(19) United States
(12) Patent Application Publication
(10) Pub. No.: US 2025/0230720 A1
(43) Pub. Date: Jul. 17, 2025

(54) METHODS FOR IDENTIFYING MUD MOTOR STALL EVENTS DURING BOREHOLE DRILLING OPERATIONS

(71) Applicant: ExxonMobil Technology and Engineering Company, Spring, TX (US)

(72) Inventors: Gregory S. PAYETTE, Spring, TX (US); Jeffrey R. BAILEY, Houston, TX (US)

(21) Appl. No.: 18/699,110

(22) PCT Filed: Sep. 19, 2022
(86) PCT No.: PCT/US2022/076663

§ 371 Date: Apr. 5, 2024

Related U.S. Application Data
(60) Provisional application No. 63/256,230, filed on Oct. 15, 2021.

(51) Int. Cl. E21B 21/08; E21B 4/02; E21B 41/00

(52) U.S. Cl. CPC E21B 21/08; E21B 4/02; E21B 41/00

(57) ABSTRACT

Methods for identifying mud motor stall events are provided herein. One method includes receiving drilling sensor data including a pressure measurement signal, calculating a smoothed pressure signal, calculating a pressure fluctuation signal, determining a pressure fluctuation distribution dataset, and calculating a set of statistical values from the pressure fluctuation distribution dataset, where the set includes a pressure fluctuation value for a selected percentile value and probability distribution parameters that characterize a selected theoretical probability distribution function. The method also includes calculating a theoretical pressure fluctuation value for another selected percentile value using the probability distribution parameters, identifying mud motor stall event(s) when a pressure measurement value from the pressure fluctuation signal is greater than the calculated pressure fluctuation value and the calculated theoretical pressure fluctuation value multiplied by a prescribed numerical value, and utilizing the identified mud motor stall event(s) to manage the borehole drilling operation.

### CROSS-REFERENCE TO RELATED APPLICATIONS

This application claims the benefit of U.S. Provisional Application No. 63/256,230, filed Oct. 15, 2021, the disclosure of which is herein incorporated by reference in its entirety.

### FIELD OF THE INVENTION

The techniques described herein relate generally to the field of borehole drilling operations. In particular, the techniques described herein relate to methods for identifying mud motor stall events during borehole drilling operations.

### BACKGROUND OF THE INVENTION

This section is intended to introduce various aspects of the art, which may be associated with embodiments of the present techniques. This discussion is believed to assist in providing a framework to facilitate a better understanding of particular aspects of the present techniques. Accordingly, it should be understood that this section should be read in this light, and not necessarily as admissions of prior art.

A mud motor is a mechanical drill string tool that is often placed within a drilling assembly during a subterranean drilling operation. Typically, a mud motor includes a top sub, a power section, a transmission section, a bearing assembly section, and a bottom sub. The top sub connects to the portion of the drill string running to surface, and the bottom sub connects to the bottom portion of the drill string. The power section contains a progressive cavity pump that typically includes a rotor and a stator. A mud motor is usually placed within a drilling assembly's bottomhole assembly (BHA), often above a rotary steerable tool or directly above the drill bit. Note that a mud motor may also be referred to as a positive displacement motor (PDM).

A mud motor is designed to receive hydraulic power that is supplied by a surface-located mud pump, which pushes drilling fluid (or mud) through the interior of the drilling assembly. The mud motor converts a portion of this hydraulic power into mechanical power, where such mechanical power is proportional to the pressure drop (or differential pressure) across the mud motor. This mechanical power manifests as an elevated rotary speed of the portion of the drill string below the mud motor (e.g., relative to the drilling assembly components above the mud motor). Moreover, the mud motor is designed to output an increased rotary speed that is proportional to the drilling fluid flow rate and the applied torque across the mud motor. For example, a mud motor configured with a speed ratio of 0.19 revolutions/gallon operated at a flow rate of 500 gallons/minute will output a relative rotation speed of about 95 revolutions/minute (assuming low torque).

In operation, a mud motor is configured to convert hydraulic power into mechanical power and to supply a relatively stable rotary speed when operated within acceptable ranges for differential pressure and drill fluid flow rate. However, when operated under improper (e.g., too high) differential pressure conditions, elastomers in the power section of the mud motor may deform excessively, causing the mud motor to lose its positive-displacement capabilities. Further increases in differential pressure will eventually cause the mud motor to be unable to convert hydraulic power into mechanical rotation, and a mud motor stall will occur. Specifically, a mud motor stall occurs when a mud motor is unable to supply enough torque to the drill bit to sustain bit rotation.

Mud motor stalls may be induced due to a number of different reasons including combinations of factors. Such factors include, for example, excessive weight on the drill bit, lithology changes within the surrounding formation, wellbore quality issues, and damage to the drill bit and/or the BHA. Moreover, mud motor stalls have the potential to cause damage to other downhole equipment, including (but not limited to) the mud motor itself, other BHA tools (such as directional and logging tools), and the drill bit. Severe mud motor stalls can lead to failures that require unwanted bit trips and expensive fishing operations (e.g., due to twist-offs).

The ability to robustly detect mud motor stalls is an extremely valuable capability. Mud motor stall detection can enable decision-making during well planning and also while drilling. In addition, mud motor stall detection can be used to provide workflows that reduce the probability of mud motor stall occurrence and the severity of actual mud motor stalls. Moreover, techniques used to detect mud motor stalls may also be used to detect downhole turbine dysfunction, where a turbine is an alternative method to generate torque at the bit. Instead of the rotor and stator used in a mud motor, a turbine has turbine blades that are more similar to an aircraft engine.

Furthermore, while there are current techniques for identifying mud motor stall events (such as, for example, the techniques described in Canadian Patent No. 3,074,312), such techniques are challenging to implement due to their reliance on comparisons between computed potential mud motor stall data and stored, historical mud motor stall data. Accordingly, there exists a need for enhanced methods for detecting mud motors stall events without relying on such data.

### SUMMARY OF THE INVENTION

An embodiment described herein provides a method for identifying one or more mud motor stall events during a borehole drilling operation that is carried out using a drilling assembly including a downhole mud motor. The method includes receiving, via a computing system, drilling sensor data that include a pressure measurement signal for a borehole drilling operation, calculating, via the computing system, a smoothed pressure signal using the received pressure measurement signal, and calculating, via the computing system, a pressure fluctuation signal using the received pressure measurement signal and the calculated smoothed pressure signal. The method includes determining, via the computing system, a pressure fluctuation distribution dataset using a subset of data for the calculated pressure fluctuation signal and calculating, via the computing system, a set of statistical values from the determined pressure fluctuation distribution dataset, where the calculated set of statistical values includes a pressure fluctuation value for a first selected percentile value and probability distribution parameters that characterize a selected theoretical probability distribution function. The method also includes calculating, via the computing system, a theoretical pressure fluctuation value for a second selected percentile value using the calculated probability distribution parameters for the selected theoretical probability distribution function and identifying, via the computing system, one or more mud motor stall events when a pressure measurement value from the calculated pressure fluctuation signal is greater than the calculated pressure fluctuation value for the first selected percentile value and is greater than the calculated theoretical pressure fluctuation value for the second selected percentile value multiplied by a prescribed numerical value. The method further includes utilizing the one or more identified mud motor stall events to manage the borehole drilling operation.

Another embodiment described herein provides another method for identifying one or more mud motor stall events during a borehole drilling operation that is carried out using a drilling assembly including a downhole mud motor. The method includes receiving, via a computing system, drilling sensor data that include a pressure measurement signal for a borehole drilling operation, calculating, via the computing system, a smoothed pressure signal using the received pressure measurement signal, and calculating, via the computing system, a pressure fluctuation signal using the received pressure measurement signal and the calculated smoothed pressure signal. The method includes determining, via the computing system, a pressure fluctuation distribution dataset using a subset of data for the calculated pressure fluctuation signal, as well as calculating, via the computing system, a set of statistical values from the determined pressure fluctuation distribution dataset, where the calculated set of statistical values includes pressure fluctuation values for first selected percentile values and probability distribution parameters that characterize a selected theoretical probability distribution function. The method also includes calculating, via the computing system, theoretical pressure fluctuation values using second selected percentile values and the calculated probability distribution parameters for the selected theoretical probability distribution function and identifying, via the computing system, one or more mud motor stall events when a pressure measurement value from the calculated pressure fluctuation signal is greater than a pressure cutoff value, where the pressure cutoff value is determined using the first selected percentile values, the second selected percentile values, the pressure fluctuation values, and the theoretical pressure fluctuation values. The method further includes utilizing the one or more identified mud motor stall events to manage the borehole drilling operation.

Another embodiment described herein provides a method for managing a borehole drilling operation that is carried out using a drilling assembly including a downhole mud motor. The method includes receiving, via a computing system, drilling sensor data that include a pressure measurement signal for a borehole drilling operation, calculating, via the computing system, a smoothed pressure signal using the received pressure measurement signal, and calculating, via the computing system, a pressure fluctuation signal using the received pressure measurement signal and the calculated smoothed pressure signal. The method also includes determining, via the computing system, a pressure fluctuation distribution dataset using a subset of the data for the calculated pressure fluctuation signal and calculating, via the computing system, a pressure fluctuation value for a selected percentile value using the determined pressure fluctuation distribution dataset. The method also includes normalizing, via the computing system, the pressure fluctuation value using a selected weighting parameter value, as well as repeating the calculation and the normalization of the pressure fluctuation value a number of times for a number of selected percentile values to obtain a time-based or depth-based signal of normalized pressure fluctuation values. The method further includes utilizing the normalized time-based or depth-based signal of normalized pressure fluctuation values to manage the borehole drilling operation.

These and other features and attributes of the disclosed embodiments of the present disclosure and their advantageous applications and/or uses will be apparent from the detailed description which follows.

### BRIEF DESCRIPTION OF DRAWINGS

To assist those of ordinary skill in the relevant art in making and using the subject matter thereof, reference is made to the appended drawings, wherein:

FIG. 1 is a schematic view of an exemplary well site for which mud motor stall event identification may be performed in accordance with the present techniques;

FIG. 2 is an exemplary days-versus-depth chart that is based on data obtained from a drilled wellbore in accordance with the present techniques;

FIG. 3A is a process flow diagram of a first exemplary method for identifying mud motor stall events in accordance with the present techniques;

FIG. 3B is a process flow diagram of a second exemplary method for identifying mud motor stall events in accordance with the present techniques;

FIG. 4 is a process flow diagram of a third exemplary method for identifying mud motor stall events in accordance with the present techniques;

FIG. 5A is a graph that provides traces of a measured differential pressure signal and a calculated average differential pressure signal vs. time in accordance with the present techniques;

FIG. 5B is a graph that provides an illustration of a calculated differential pressure fluctuation signal in accordance with the present techniques;

FIG. 6 is an exemplary days-versus-depth chart that is based on data obtained from a drilled wellbore in accordance with the present techniques;

FIG. 7 is an exemplary days-versus-depth chart for an interval of drilling, which is referred to as Interval 1, in accordance with the present techniques;

FIG. 8 is another exemplary days-versus-depth chart for another interval of drilling, which is referred to as Interval 2, in accordance with the present techniques;

FIG. 9A is a histogram representation of a distribution of differential pressure fluctuation data for an interval of drilling time for a drilled wellbore, where the interval is labeled as Interval 1, in accordance with the present techniques;

FIG. 9B is a zoomed-in view of the histogram representation of FIG. 9A in accordance with the present techniques;

FIG. 9C is a histogram representation of a distribution of differential pressure fluctuation data for an interval of drilling time for a drilled wellbore, where the interval is labeled as Interval 2, in accordance with the present techniques;

FIG. 9D is a zoomed-in view of the histogram representation of FIG. 9C in accordance with the present techniques;

FIG. 10A is a graph including traces of a measured differential pressure signal P=P_{Diff} versus time and a calculated average differential pressure signal versus time for a subset of data from Interval 1, where such subset is taken from 12 hours of on-bottom drilling data from Interval 1, in accordance with the present techniques;

FIG. 10B is graph including traces of a calculated differential pressure fluctuation signal, P_{fluct}, versus time, as well as calculated mud motor stall events for the subset of data from Interval 1, in accordance with the present techniques;

FIG. 11A is a graph including traces of a measured differential pressure signal versus time and a calculated average differential pressure signal versus time for a subset of data from Interval 1 in accordance with the present techniques;

FIG. 11B is a graph including traces of a calculated differential pressure fluctuation signal, P_{fluct}, versus time, as well as calculated mud motor stall events for the subset of data from Interval 1, in accordance with the present techniques;

FIG. 12A is a graph including traces of a measured differential pressure signal versus time and a calculated average differential pressure signal versus time for a subset of data from Interval 2, in accordance with the present techniques;

FIG. 12B is a graph including traces of a calculated differential pressure fluctuation signal, P_{fluct}, versus time, as well as calculated mud motor stall events for the subset of data from Interval 2, in accordance with the present techniques;

FIG. 13A provides traces of a measured Differential Pressure signal and a calculated Average Differential Pressure signal vs. time for a subset of data from Interval 2 in accordance with the present techniques;

FIG. 13B provides an illustration of a calculated Differential Pressure Fluctuation signal vs. time and marked mud motor stall events in accordance with the present techniques;

FIG. 14A is an exemplary days-versus-depth chart that is based on data obtained from a drilled wellbore in accordance with the present techniques;

FIG. 14B is a graph showing traces of calculated differential pressure fluctuation signals, {P_{α}}, versus time for the following selected percentile values: {αᵢ}: 98.5%, 99%, 99.25%, 99.5%, 99.75% and 99.9%, in accordance with the present techniques;

FIG. 14C is a graph showing ratio traces, R_{α}(t), between the calculated differential pressure fluctuation signals, {P_{α}}, and the theoretical differential pressure fluctuation signals, {P_{theory,α}}, versus time for the following selected percentile values: 98.5%, 99%, 99.25%, 99.5%, 99.75% and 99.9%, in accordance with the present techniques;

FIG. 15A is a days-versus-depth chart for a subset of data from Interval 1 in accordance with the present techniques;

FIG. 15B is a graph showing traces of calculated differential pressure fluctuation values versus time for the following selected percentile values: 98.5%, 99%, 99.25%, 99.5%, 99.75% and 99.9%, in accordance with the present techniques;

FIG. 15C is a graph showing ratio traces between the calculated differential pressure fluctuation signals and the theoretical differential pressure fluctuation signals versus time for the following selected percentile values: 98.5%, 99%, 99.25%, 99.5%, 99.75% and 99.9%, in accordance with the present techniques;

FIG. 16A is a days-versus-depth chart for a subset of data from Interval 2 in accordance with the present techniques;

FIG. 16B is a graph showing traces of calculated differential pressure fluctuation values versus time for the following selected percentile values: 98.5%, 99%, 99.25%, 99.5%, 99.75% and 99.9%, in accordance with the present techniques;

FIG. 16C is a graph showing ratio traces between the calculated differential pressure fluctuation signals and the theoretical differential pressure fluctuation signals versus time for the following selected percentile values: 98.5%, 99%, 99.25%, 99.5%, 99.75% and 99.9%, in accordance with the present techniques;

FIG. 17A is a graph showing ratio traces, R(s;t), between the calculated differential pressure fluctuation signals and the theoretical differential pressure fluctuation signals versus time for a normal distribution, as a function of standard score s and time t, in accordance with the present techniques;

FIG. 17B is a graph showing traces of derivatives of the traces found in FIG. 17A, with respect to the standard score s in accordance with the present techniques;

FIG. 18 is a process flow diagram of a method for using characteristics of R(s;t) to determine a pressure cutoff threshold, P_{cutoff}, to be used to identify mud motor stall events in accordance with the present techniques;

FIG. 19 provides an example of the manner in which the method of FIG. 18 might be used to carry out an embodiment of the present techniques for data from Interval 1 and data from Interval 2 in accordance with the present techniques;

FIG. 20A is a graph providing differential pressure traces and identified mud motor stall events for data from Interval 1 in accordance with the present techniques;

FIG. 20B is a graph providing differential pressure fluctuation traces and identified mud motor stall events for data from Interval 1 in accordance with the present techniques;

FIG. 21A is a graph providing differential pressure traces and identified mud motor stall events for data from Interval 2 in accordance with the present techniques;

FIG. 21B is a graph providing differential pressure fluctuation traces and identified mud motor stall events for data from Interval 2 in accordance with the present techniques;

FIG. 22 is a block diagram of an exemplary cluster computing system that may be utilized to implement mud motor stall event identification in accordance with the present techniques; and

FIG. 23 is a block diagram of an exemplary non-transitory, computer-readable storage medium (or media) that may be used for the storage of data and modules of program instructions for implementing mud motor stall event identification in accordance with the present techniques.

It should be noted that the figures are merely examples of the present techniques and are not intended to impose limitations on the scope of the present techniques. Further, the figures are generally not drawn to scale, but are drafted for purposes of convenience and clarity in illustrating various aspects of the techniques.

### DETAILED DESCRIPTION OF THE INVENTION

In the following detailed description section, the specific examples of the present techniques are described in connection with preferred embodiments. However, to the extent that the following description is specific to a particular embodiment or a particular use of the present techniques, this is intended to be for example purposes only and simply provides a description of the embodiments. Accordingly, the techniques are not limited to the specific embodiments described below, but rather, include all alternatives, modifications, and equivalents falling within the true spirit and scope of the appended claims.

### Terminology

At the outset, and for ease of reference, certain terms used in this application and their meanings as used in this context are set forth. To the extent a term used herein is not defined below, it should be given the broadest definition those skilled in the art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As used herein, the singular forms “a,” “an,” and “the” mean one or more when applied to any embodiment described herein. The use of “a,” “an,” and/or “the” does not limit the meaning to a single feature unless such a limit is specifically stated.

The terms “about” and “around” mean a relative amount of a material or characteristic that is sufficient to provide the intended effect. The exact degree of deviation allowable in some cases may depend on the specific context, e.g., ±1%, ±5%, ±10%, ±15%, etc. It should be understood by those of skill in the art that these terms are intended to allow a description of certain features described and claimed without restricting the scope of these features to the precise numerical ranges provided. Accordingly, these terms should be interpreted as indicating that insubstantial or inconsequential modifications or alterations of the subject matter described are considered to be within the scope of the disclosure.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

The phrase “at least one,” in reference to a list of one or more entities, should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A or B” (or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase “based on” does not mean “based only on,” unless expressly specified otherwise. In other words, the phrase “based on” means “based only on,” “based at least on,” and/or “based at least in part on.”

As used herein, the term “configured” means that a given element, component, or other subject matter is designed and/or intended to perform a given function. Thus, the use of the term “configured” should not be construed to mean that the given element, component, or other subject matter is simply “capable of” performing a given function, but that the element, component, or other subject matter is specifically selected, created, implemented, utilized, and/or designed for the purpose of performing the function.

The term “drilling operation” refers to the process of creating a wellbore (or borehole) passing through various subterranean formations for the purpose of subsurface mineral extraction. A drilling operation is conducted using a drilling rig, which raises and lowers a drill string composed of joints of tubular components of various sizes. A drill bit is located at the end of the drill string and is used to penetrate the subterranean formations by mechanisms of crushing and/or slicing the rock. The power required to advance the drill bit is provided by motors which rotate the drill pipe and lower the drilling assembly and mud pumps, allowing the drilling fluid to be conveyed through the drilling assembly and back up the annulus. A drilling operation typically proceeds on a section-by-section basis, with each section designated as a “hole section”. A drilled wellbore typically possesses a number of hole sections, including, for example, a conductor hole section, a surface hole section, various intermediate hole sections and a production hole section. A drilled wellbore will sometimes include one or more “side tracks,” where a side track is a secondary wellbore drilled away from an original wellbore (typically to bypass an unusable original wellbore section). Moreover, an “offset well” refers to a well that is within some proximity to a well of interest. However, as used herein, there is no distinction between a section of an offset well and a previously-drilled section of the same well, as both provide historical drilling parameters that may be analyzed to determine a drilling parameter set for a future drilling interval.

The term “drilling parameters” refers to measurable physical and/or operational parameters of a drilling operation and/or the associated drilling equipment, as well as parameters that can be calculated therefrom and are useful information in monitoring, operating, and/or predicting aspects of the drilling operation.

The term “drill string assembly” (or “drill string” or “drilling assembly”) refers to a collection of connected tubular components that are used in drilling operations to drill a wellbore through a subterranean formation. Exemplary components that may collectively or individually be considered part of the drill string include rock cutting devices (such as drill bits, mills, and reamers), bottom hole assemblies, drill collars, mud motors, drill pipe, cross overs, subs, stabilizers, roller reamers, MWD (measurement-while-drilling) tools, and LWD (logging-while-drilling) tools.

As used herein, the terms “example,” exemplary,” and “embodiment,” when used with reference to one or more components, features, structures, or methods according to the present techniques, are intended to convey that the described component, feature, structure, or method is an illustrative, non-exclusive example of components, features, structures, or methods according to the present techniques. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present techniques.

As used herein, the term “fluid” refers to gases and liquids, as well as to combinations of gases and liquids, combinations of gases and solids, combinations of liquids and solids, and combinations of gases, liquids, and solids.

“Formation” refers to a subsurface region including an aggregation of subsurface sedimentary, metamorphic and/or igneous matter, whether consolidated or unconsolidated, and other subsurface matter, whether in a solid, semi-solid, liquid and/or gaseous state, related to the geological development of the subsurface region. A formation can be a body of geologic strata of predominantly one type of rock or a combination of types of rock, or a fraction of strata having substantially common sets of characteristics. A formation can contain one or more hydrocarbon-bearing intervals, generally referred to as “reservoirs.” Note that the terms “formation,” “reservoir,” and “interval” may be used interchangeably, but may generally be used to denote progressively smaller subsurface regions, stages, or volumes. More specifically, a “formation” may generally be the largest subsurface region, while a “reservoir” may generally be a hydrocarbon-bearing stage or interval within the geologic formation that includes a relatively high percentage of oil and gas. Moreover, an “interval” may generally be a sub-region or portion of a reservoir. In some cases, a hydrocarbon-bearing stage, or reservoir, may be separated from other hydrocarbon-bearing stages by stages of lower permeability, such as mudstones, shales, or shale-like (e.g., highly-compacted) sands.

The term “gas” is used interchangeably with “vapor,” and is defined as a substance or mixture of substances in the gaseous state as distinguished from the liquid or solid state. Likewise, the term “liquid” means a substance or mixture of substances in the liquid state as distinguished from the gas or solid state.

A “hydrocarbon” is an organic compound that primarily includes the elements hydrogen and carbon, although nitrogen, sulfur, oxygen, metals, or any number of other elements may be present in small amounts. As used herein, the term “hydrocarbon” generally refers to components found in natural gas, oil, or chemical processing facilities. Moreover, the term “hydrocarbon” may refer to components found in raw natural gas, such as CH₄, C₂H₂, C₂H₄, C₂H₆, C₃ isomers, C₄ isomers, benzene, and the like.

The term “mud motor” (or “downhole mud motor” or “turbine motor” or “downhole turbine motor”) refers to a drill string tool that converts hydraulic power into mechanical power to supply torque to the drill bit. A traditional mud motor typically consists of a top sub, a power section, a transmission section, a bearing assembly section, and a bottom sub. The top sub connects to the portion of the drill string running to surface, and the bottom sub connects to the bottom portion of drill string. The mud motor power section typically contains a progressive cavity pump that includes a rotor and a stator. A mud motor is usually placed within a drilling assembly's BHA, often above a rotary steerable tool or directly above the drill bit. Mud motors receive hydraulic power that is supplied by surface-located mud pumps that push drilling fluid through the interior of the drilling assembly. A mud motor converts a portion of the mud-pump-supplied hydraulic power into mechanical power. This mechanical power is proportional to the pressure drop (or differential pressure) across the mud motor and manifests in torque and an elevated rotary speed of the portion of the drill string below the mud motor (relative to the drilling assembly components above the mud motor). A mud motor is designed to output an increased rotary speed that is proportional to the drilling fluid (or mud) flow rate and the applied torque across the mud motor. Turbine motors are technologically somewhat distinct from traditional mud motors, but they provide similar functionality. Therefore, as used herein, there is no differentiation between mud motors and turbine motors; rather, both are simply referred to as mud motors.

The term “production tubing” refers to a wellbore tubular used to produce hydrocarbon fluids from a reservoir.

The term “substantially,” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

The term “wellbore” refers to a borehole drilled into a subterranean formation. The borehole may include vertical, deviated, highly deviated, and/or horizontal sections. The term “wellbore” also includes the downhole equipment associated with the borehole, such as the casing strings, production tubing, gas lift valves, and other subsurface equipment. Relatedly, the term “hydrocarbon well” (or simply “well”) includes the wellbore in addition to the wellhead and other associated surface equipment.

Certain embodiments and features are described herein using a set of numerical upper limits and a set of numerical lower limits. It should be appreciated that ranges from any lower limit to any upper limit are contemplated unless otherwise indicated. All numerical values are “about” or “approximately” the indicated value, and account for experimental errors and variations that would be expected by those skilled in the art.

Furthermore, concentrations, dimensions, amounts, and/or other numerical data that are presented in a range format are to be interpreted flexibly to include not only the numerical values explicitly recited as the limits of the range, but also all individual numerical values or sub-ranges encompassed within that range, as if each numerical value and sub-range were explicitly recited. For example, a disclosed numerical range of 1 to 200 should be interpreted to include, not only the explicitly-recited limits of 1 and 200, but also individual values, such as 2, 3, 4, 197, 198, 199, etc., as well as sub-ranges, such as 10 to 50, 20 to 100, etc.

### Overview

As described above, the ability to identify mud motor stall events is an extremely valuable capability. Mud motor stall event identification can enable decision-making during well planning and also while drilling. In addition, mud motor stall event identification can be used to provide workflows that reduce the probability of mud motor stall occurrence and the severity of actual mud motor stalls. Furthermore, while there are current techniques for identifying mud motor stall events, such techniques are challenging to implement due to their reliance on comparisons between computed potential mud motor stall data and stored, historical mud motor stall data. Accordingly, there exists a need for enhanced methods for detecting mud motors stall events without relying on such data.

Accordingly, embodiments described herein provide methods for determining mud motor stall events using sensor measurement data that are collected while drilling. More specifically, embodiments described herein provide methods for identifying mud motor stall events and characterizing the severity of such mud motor stall events during borehole drilling operations that are carried out using drill string assemblies that include downhole mud motors. According to embodiments described herein, this is accomplished using pressure measurement signals that are taken at discrete points in time at frequencies that are suitable for detecting mud motor stall events, as described further herein. Notably, the present techniques do not require driller-prescribed threshold values for pressure but, instead, are capable of being implemented using drilling sensor data as the primary input. Furthermore, due to the fact that the present techniques do not rely on the utilization of historical mud motor stall event data, such techniques are capable of being applied directly to any borehole drilling operation.

Exemplary Well Site for which Mud Motor Stall Event Identification May be Performed

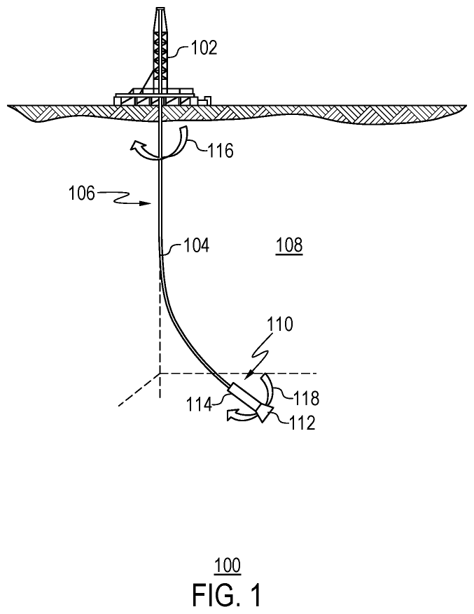

FIG. 1 is a schematic view of an exemplary well site 100 for which mud motor stall event identification may be performed in accordance with the present techniques. The well site 100 includes a drilling rig 102 at the surface with a drill string 104 that extends through the subsurface, creating a wellbore 106 within the surrounding subterranean formation 108. As shown in FIG. 1, the drill string 104 includes a bottomhole assembly (BHA) 110 with a drill bit 112 and an attached mud motor 114. During the drilling operation, torque is applied via the rotation of the drill string 104, as indicated by arrow 116, and via the rotation of the drill bit 112, as indicated by arrow 118. Moreover, the mud motor 114 is used to elevate the rotary speed of the drill bit 112 to enable efficient directional drilling for non-vertical portions of the wellbore 106, as shown in FIG. 1.

In various embodiments, the wellbore 106 is drilled as a portion of an existing hydrocarbon well or as an offset well that is drilled in the vicinity of a proposed well site. In particular, offset wells are often utilized to provide data that are useful for planning and designing various aspects of a hydrocarbon well (e.g., either a new hydrocarbon well or an existing hydrocarbon well that is either currently operating or was previously operated). Such data may include, for example, data relating to the subsurface geology and other relevant conditions within the formation 108. Such data may then be combined with other data obtained from the prior drilling of the proposed well site and/or from one or more other offset wells within the vicinity of the proposed well site. In some embodiments, such data also include information relating to the drilling RPM speeds, bit weight, bit type, applied torque, and/or drill string configuration, for example, for each drilling operation (e.g., for each offset well). Furthermore, because the offset wells are typically similar in design and configuration to the proposed well site, such data may be valuable for determining mud motor stall event histories, as well as for quantitatively evaluating available means to mitigate and/or minimize future mud motor stall events, as described further herein.

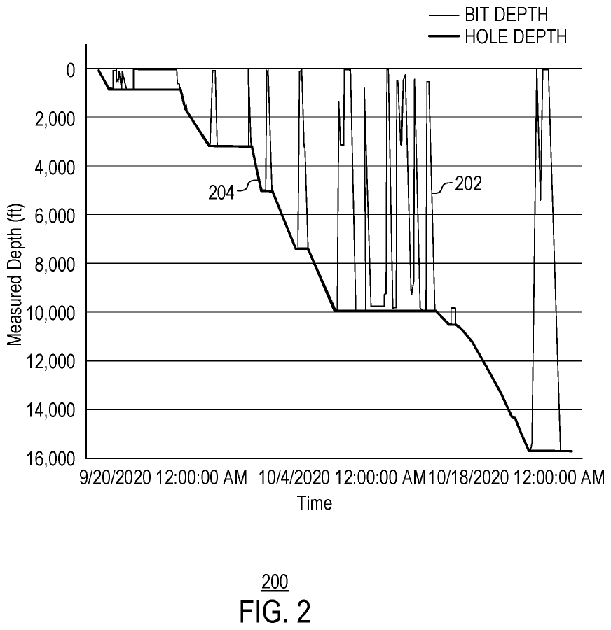

An example of such data is shown in FIG. 2. Specifically, FIG. 2 is an exemplary days-versus-depth chart 200 that is based on data obtained from a drilled wellbore in accordance with the present techniques. The days-versus-depth chart 200 provides traces of drill bit depth as a function of time, as shown at 202, and hole depth as a function of time, as shown at 204.

### Exemplary Methods for Identifying Mud Motor Stall Events

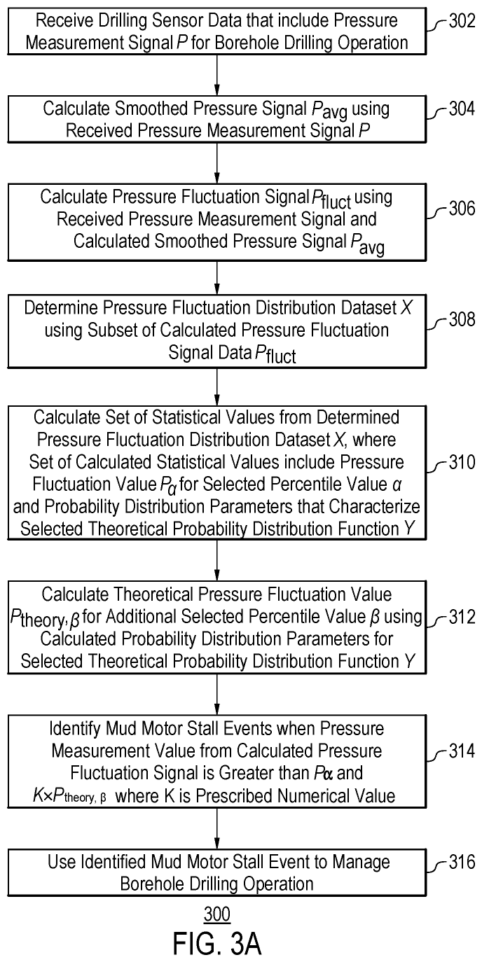

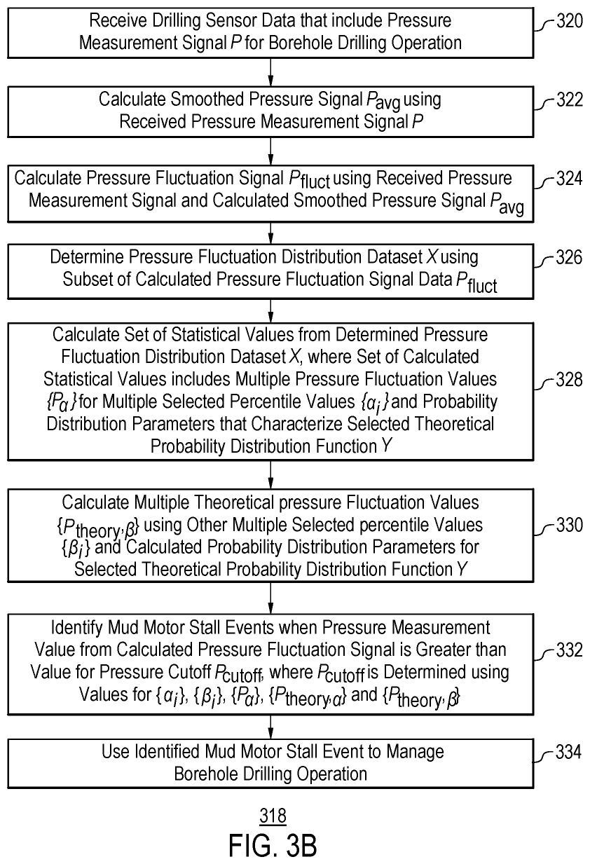

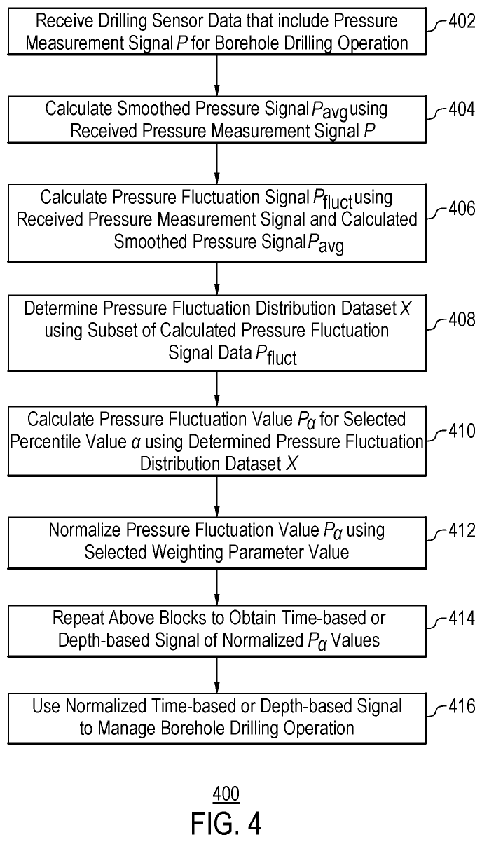

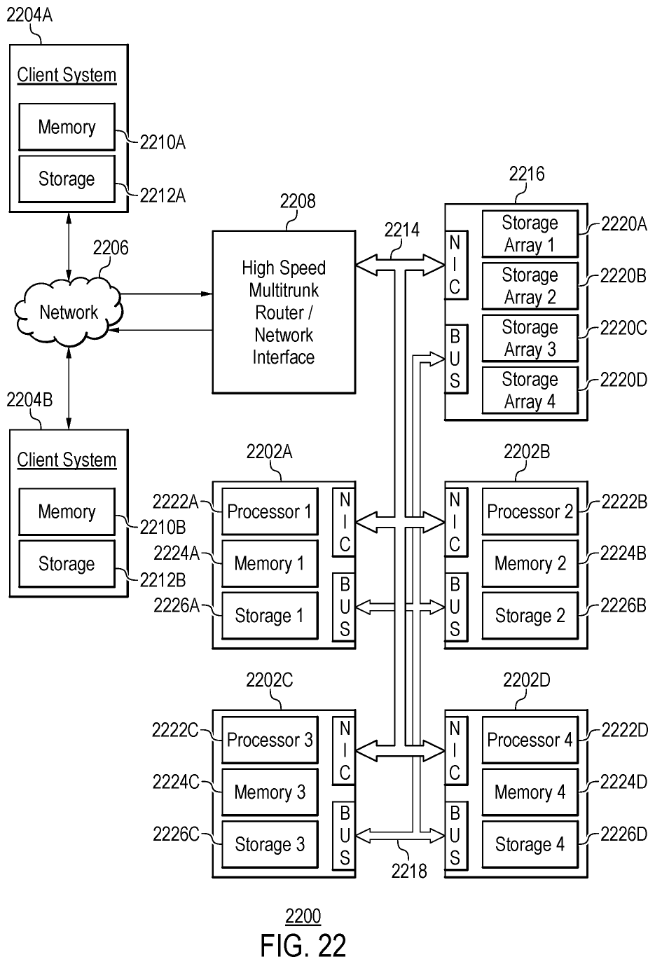

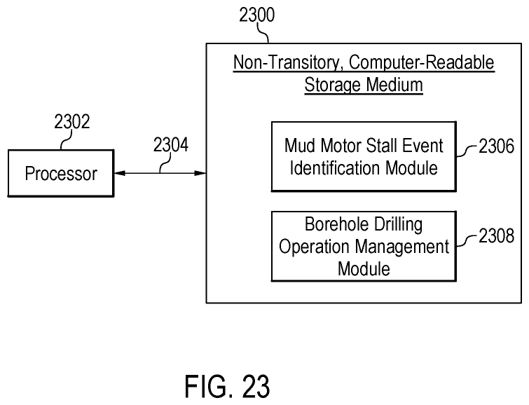

FIGS. 3A, 3B, and 4 provide exemplary embodiments of methods for identifying mud motor stall events according to the present techniques. Such methods are implemented (at least in part) using one or more computing systems, such as the exemplary cluster computing system described with respect to FIG. 22. Moreover, such methods may be executed by the computing system(s) using one or more non-transitory, computer-readable storage media, such as the exemplary non-transitory, computer-readable storage medium described with respect to FIG. 23.

Turning now to the details of such methods, FIG. 3A is a process flow diagram of a first exemplary method 300 for identifying mud motor stall events in accordance with the present techniques. The method 300 begins at block 302 with the receipt of drilling sensor data that include a pressure measurement signal, P, for a borehole drilling operation. At block 304, a smoothed pressure signal, P_{avg}, is calculated using the received pressure measurement signal, P. In some embodiments, this includes performing signal smoothing on the received pressure measurement signal to generate an initial smoothed pressure signal, comparing the initial smoothed pressure signal with a processed pressure measurement signal (e.g., a version of the pressure measurement signal that has been processed using Savitzky-Golay filtering techniques), and calculating the smoothed pressure signal based on the comparison between the initial smoothed pressure signal and the processed pressure measurement signal. At block 306, a pressure fluctuation signal, P_{fluct}, is calculated using the received pressure measurement signal and the calculated smoothed pressure signal, P_{avg}. At block 308, a pressure fluctuation distribution dataset, X, is determined using a subset of the calculated pressure fluctuation signal data, P_{fluct}.

At block 310, a set of statistical values is calculated from the determined pressure fluctuation distribution dataset, X, where the calculated set of statistical values includes a pressure fluctuation value, P_{α} for a selected percentile value, α, and probability distribution parameters that characterize a selected theoretical probability distribution function, Y. At block 312, a theoretical pressure fluctuation value, P_{theory,β}, is calculated for an additional selected percentile value, β, using the calculated probability distribution parameters for the selected theoretical probability distribution function, Y. At block 314, mud motor stall events are identified when a pressure measurement value from the calculated pressure fluctuation signal is greater than P_{α} and K×P_{theory,β}, where K is a prescribed numerical value. Furthermore, at block 316, the identified mud motor stall events are used to manage the borehole drilling operation.

FIG. 3B is a process flow diagram of a second exemplary method 318 for identifying mud motor stall events in accordance with the present techniques. The method 318 begins at block 320 with the receipt of drilling sensor data that include a pressure measurement signal, P, for a borehole drilling operation. At block 322, a smoothed pressure signal, P_{avg}, is calculated using the received pressure measurement signal, P. At block 324, a pressure fluctuation signal, P_{fluct}, is calculated using the received pressure measurement signal and the calculated smoothed pressure signal, P_{avg}. At block 326, a pressure fluctuation distribution dataset, X, is determined using a subset of the calculated pressure fluctuation signal data, P_{fluct}.

At block 328, a set of statistical values is calculated from the determined pressure fluctuation distribution dataset, X, where the calculated set of statistical values includes multiple pressure fluctuation values, {P_{α}}, for multiple selected percentile values, {αᵢ}, and probability distribution parameters that characterize a selected theoretical probability distribution function, Y. At block 330, multiple theoretical pressure fluctuations values, {P_{theory,β}}, are calculated using other multiple selected percentile values, {βᵢ}, and the calculated probability distribution parameters for the selected theoretical probability distribution function, Y.

At block 332, mud motor stall events are identified when a pressure measurement value from the calculated pressure fluctuation signal is greater than the value for a pressure cutoff, P_{cutoff}, where P_{cutoff} is determined using the values for {αᵢ}, {βᵢ}, {P_{α}}, {P_{theory,α}}, and {P_{theory,β}}. At block 334, the identified mud motor stall events are then used to manage the borehole drilling operation.

FIG. 4 is a process flow diagram of a third exemplary method 400 for identifying mud motor stall events in accordance with the present techniques. The method 400 begins at block 402 with receipt of drilling sensor data that include a pressure measurement signal, P, for a borehole drilling operation. At block 404, a smoothed pressure signal, P_{avg}, is calculated using the received pressure measurement signal, P. At block 406, a pressure fluctuation signal, P_{fluct}, is calculated using the received pressure measurement signal and the calculated smoothed pressure signal, P_{avg}. At block 408, a pressure fluctuation distribution dataset, X, is determined using a subset of the calculated pressure fluctuation signal data, P_{fluct}.

At block 410, a pressure fluctuation value, P_{α}, is calculated for a selected percentile value, α, using the determined pressure fluctuation distribution dataset, X. At block 412, the pressure fluctuation value, P_{α}, is normalized using a selected weighting parameter value. At block 414, blocks 410 and 412 are repeated a number of times for a number of selected percentile values to obtain a time-based or depth-based signal of normalized pressure fluctuation values P_{α}. Moreover, at block 416, the normalized time-based or depth-based signal is used to manage the borehole drilling operation.

The process flow diagrams of FIGS. 3A, 3B, and 4 are not intended to indicate that the steps of the respective methods 300, 318, and 400 are to be executed in any particular order, or that all of the steps of the methods 300, 318, and/or 400 are to be included in every case. Further, any number of additional steps not shown in FIGS. 3A, 3B, and/or 4 may be included within the respective methods 300, 318, and 400, depending on the details of the specific implementation.

In some embodiments, the methods 300, 318, and/or 400 include determining trends for a number of mud motor stall events that occur over time and utilizing such trends to manage the borehole drilling operation. In some embodiments, the selected theoretical probability distribution function is a Gaussian distribution, and the calculated set of statistical values includes a mean and a standard deviation. In some embodiments, the methods 300, 318, and/or 400 include identifying the subset of data for determining the pressure fluctuation distribution dataset by filtering out data based on an analysis of operational activities, ranges for set point parameters, and/or formation characteristics.

In some embodiments, the methods 300, 318, and/or 400 include obtaining the drilling sensor data during a period of time when control system set points for the borehole drilling operation are steady. In some embodiments, the methods 300, 318, and/or 400 include selecting the theoretical probability distribution function such that the theoretical probability distribution function includes all data from the subset of data used to determine the pressure fluctuation distribution dataset except for data in an upper percentile range (e.g., an upper 2 percentile range) and data in a corresponding lower percentile range (e.g., a lower 2 percentile range). Moreover, in some embodiments, the methods 300, 318, and/or 400 include utilizing a number of identified mud motor stall events over a period of time (and the pressure fluctuation values) to analyze the cumulative severity of mud motor damage over the period of time and determining an optimal time to replace the mud motor based on the cumulative severity of mud motor damage over the period of time (and the pressure fluctuation values).

### Exemplary Embodiments of the Present Techniques

According to embodiments described herein, the following drilling data (or drilling data signals) may be obtained from measurement devices or through calculations that use data obtained from measurement devices. These quantities may be acquired or calculated at various times (and/or at various depths) during borehole drilling operations.
t=time
MD=the measured “bit depth”.
HD=the measured “hole depth”.
HL=the measured “hook load”.
WOB=the “weight on bit”, the applied load or force along the axis of the bit.
BH=the position of the traveling block relative to some datum. Also known as the block height or block position.
ROP=the “rate of penetration”, generically, the velocity of pipe.
TQ=the “torque”, generically, the pipe torque about its axis.
TQ_{S}=the “surface torque”, the torque of the drill string as measured at the surface.
TQ_{B}=the “downhole torque”, the torque of the drill string as measured or calculated at the drill bit or downhole mud motor.
RPM=the “rotary speed”, generically, the rate of rotation of pipe about its axis.
RPM_{S}=the “surface RPM”, the rotary speed of the drill string as measured at the surface in revolutions per minute.
RPM_{B}=the “downhole RPM”, the rotary speed of the drill string as measured or calculated at the drill bit or downhole mud motor in revolutions per minute.
FLOW=the “flow rate” of the drilling fluid through the drill string.
P=the “pressure”, generically.
P_{SP}=the “stand pipe pressure”, the surface measured pressure of the drilling fluid being pumped through the drilling assembly.
P_{CP}=the “casing pressure”, the surface measured pressure of the drilling fluid in the annulus.
P_{Diff}=the “differential pressure”, the pressure drop across the downhole mud motor.

The following list of additional parameters are also utilized for embodiments described herein. However, the scope of the present techniques are not limited to use of these specific parameters.
P_{avg}=the “smoothed pressure” or “averaged pressure”, generically. This quantity may be, but is not limited to, a smoothing of P_{SP}, P_{CP}, or P_{Diff}.
P_{fluct}=the “pressure fluctuation”, generically. This quantity is obtained by subtracting P_{avg} from a corresponding received pressure value P or from a processed received pressure value.
X̅=a “pressure fluctuation population” set of data, generically. The elements in the set include P_{fluct} values that may be indexed by time or depth. This set may be used to determine a pressure fluctuation population distribution.
X=a “pressure fluctuation sample”, generically, where X⊂X̅. This set may be used to determine a pressure fluctuation sample distribution. To simplify notation, X may be referred to as either the “sample” itself or the “distribution” associated with the sample.
Y=a “theoretical pressure fluctuation distribution”, generically.
SE=a mud motor “stall event” indicator.
S=the “standard deviation” generically for the sample population X.
S=the “standard score”, generically of an actual data point (or hypothetical data point) from the sample population X. The standard score is the number of standard deviations by which the data point is above or below the mean value of the population X.
α=a selected “percentile value”, generically. This quantity may be expressed as a percentage, e.g., α∈(0%, 100%), or a decimal, e.g., α∈(0, 1). Examples include 65% (or 0.65), 99% (or 0.99) and 99.5% (or 0.995).
αᵢ=a selected “percentile value”, generically, for an index i.
β=another selected “percentile value”, generically.
βᵢ=another selected “percentile value”, generically, for an index i.
P_{α}=a “pressure fluctuation” value from X, for a selected percentile value α.
P_{theory,α}=the “theoretical pressure fluctuation” value from Y, for a selected percentile value α.
{αᵢ}=a set of selected “percentile values”, generically.
{P_{α}}=a set of “pressure fluctuation” values from X, for a set of selected percentile values {αᵢ}, where such pressure fluctuation values are indexed by i.
{P_{theory,α}}=a set of “theoretical pressure fluctuation” values from Y, for a set of selected percentile values {αᵢ}, where such theoretical pressure fluctuation values are indexed by i.
P_{cutoff}=a “pressure fluctuation cutoff” value for mud motor stall detection, which is determined using {αᵢ}, {P_{α}}, and {P_{theory,α}}.
T=a “period” of time, generically. This may be associated with a measured signal or an algorithm that performs averaging.
ΔTQ=the surface torque-swing (maximum TQ_{S} minus minimum TQ_{S}) over a defined or calculated time period T.

According to embodiments described herein, computer-implemented techniques are used to detect mud motor stall events using drilling parameter information. Such techniques utilize a pressure measurement signal P, which may include a stand pipe pressure signal, P_{SP}, or a mud motor differential pressure signal, P_{Diff}. However, the pressure measurement signal P may alternatively be any other suitable type of pressure signal.

The pressure measurement signal is represented by the computer-implemented technique through discrete measurements in time. According to embodiments described herein, an index symbol j is adopted for records of signal measurements at discrete times. For example, Pⱼ means P evaluated at time tⱼ, as shown in equation (Eq. 1).

$${P}_{j} ≡ P ( t = {t}_{j} ) \qquad ( Eq . 1 )$$

The current techniques rely on the utilization of discrete pressure signals that are at a frequency that is suitable for mud motor stall detection. In some embodiments, the minimum required frequency is around 1 Hz, although the particular minimum required frequency is specific to each drilling operation.

In various embodiments, computer-implemented techniques are used to calculate smoothed pressure signal values, P_{avg}, using the received pressure signal, P. Those skilled in the art of signal processing will appreciate that there are multiple smoothing or averaging techniques available for this purpose. For example, signal smoothing via a simple weighted averaging procedure may be implemented as shown in equation (Eq. 2).

$${P}_{avg , j} = \frac{1}{W} {\sum }_{k = - n}^{m} {w}_{k} {P}_{j + k} \qquad ( Eq . 2 )$$

In equation (Eq. 2), P_{avg,j} is a discrete smoothed (averaged) value of P at time tⱼ. The quantities m and n are non-negative integers for the chosen averaging scheme, and wₖ are averaging scheme weights. The quantity W represents a summation of weights as shown in equation (Eq. 3).

$$W = {\sum }_{k = - n}^{m} {w}_{k} \qquad ( Eq . 3 )$$

The present techniques are not limited to the use of the averaging scheme shown in equation (Eq. 2). For example, more advanced signal processing techniques may be adopted to perform signal smoothing. A few additional examples of signal smoothing procedures include exponential moving averaging, median averaging, Savitzky-Golay filtering, and regression averaging. Other averaging procedures known to those skilled in the art may also be used according to embodiments described herein.

The discrete smoothed pressure signal, P_{avg,j}, may be used to calculate a pressure fluctuation signal, P_{fluct}. In some embodiments, the discrete pressure fluctuation signal, P_{fluct,j}, may be determined as provided by equation (Eq. 4).

$${P}_{fluct , j} = {P}_{j} - {P}_{avg , j} \qquad ( Eq . 4 )$$

The purpose of the pressure fluctuation signal, P_{fluct,j}, is to provide a signal that represents variability in time of the discrete pressure signal, Pⱼ. Therefore, the discrete smoothing scheme for P_{avg,j} is implemented such that relevant pressure variability data are captured by P_{fluct,j}. Moreover, to ensure that mud motor stall events are captured, suitable signal variabilities are utilized, while unwanted variations caused by other factors are removed.

For example, in some embodiments, signal smoothing of the received pressure signal may be implemented so as to remove artifacts associated with changes made to drilling control system parameter set points, such as weight on bit (WOB), rate of penetration (ROP), flow rate (FLOW) and rotary speed (RPM). In addition, smoothing may also be implemented to remove unwanted P_{fluct,j} variations that are due to formation lithology changes. In such cases, a processed version of the received signal is still considered to be the received pressure signal according to embodiments described herein.

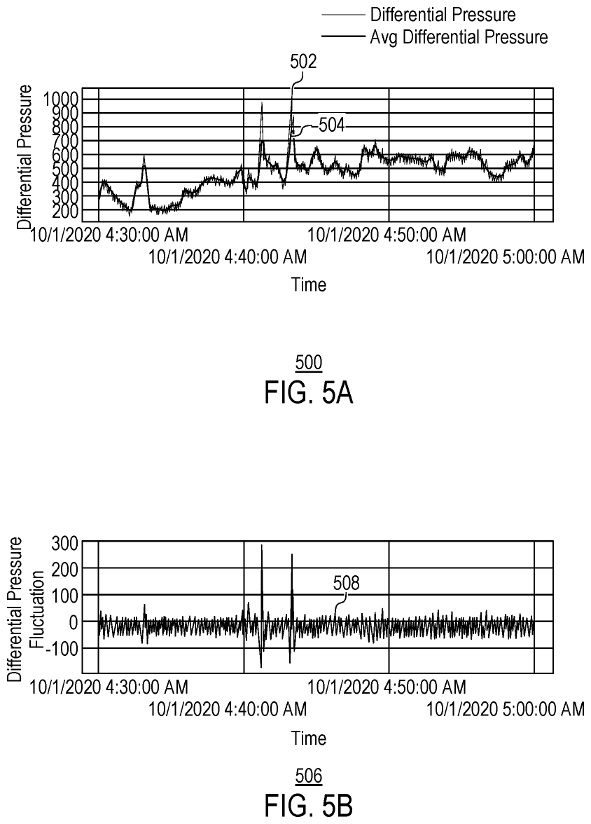

An exemplary embodiment of the present techniques is shown in FIGS. 5A and 5B. Specifically, FIG. 5A is a graph 500 that provides traces of a measured differential pressure signal and a calculated average differential pressure signal versus time in accordance with the present techniques. Specifically, the graph 500 shows a discrete differential pressure signal, P_{Diff,j}, as a function of time, as shown at 502, and a calculated smoothed pressure signal, P_{avg,j}, as a function of time, as shown at 504. The data shown in this exemplary embodiment are of uniform, 1-Hz frequency, and a simple smoothing scheme based on equation (Eq. 1) has been used, where n=m=15.

FIG. 5B is a graph 506 that provides an illustration of a calculated differential pressure fluctuation signal in accordance with the present techniques. In particular, the graph 506 shows a computed pressure fluctuation signal, P_{fluct,j}, as a function of time, as shown at 508. For this exemplary embodiment, the computed pressure fluctuation signal, P_{fluct,j}, uses the data shown in FIG. 5A in combination with equation (Eq. 4) by subtracting the calculated average differential pressure signal from the measured differential pressure signal. From an inspection of FIG. 5B, those skilled in the art will observe that short time-scale variations have been retained in P_{fluct,j}, while longer time-scale variations have been effectively removed.

According to embodiments described herein, mud motor stall events are identified via analysis of P_{fluct,j} data points contained in a pressure fluctuation population dataset, X̅. The elements of the population X̅ include all pressure fluctuation values, P_{fluct,j}, received during the computer-implemented method. This population may grow over time as additional data are acquired during the computer-implemented method (e.g., for embodiments corresponding to real-time drilling operations). Moreover, the techniques described herein may be applied to the entire dataset, X̅, or to a sample dataset, X⊂X̅.

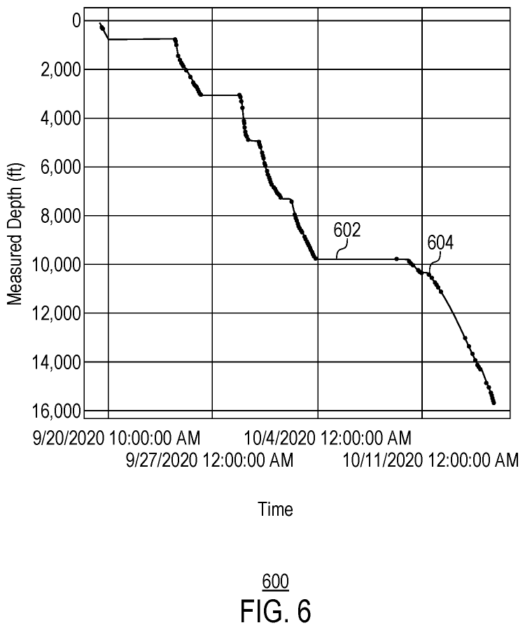

FIG. 6 is an exemplary days-versus-depth chart 600 that is based on data obtained from a drilled wellbore in accordance with the present techniques. Specifically, the days-versus-depth chart 600 provides a measured hole depth curve 602 as function of time for the same well that is represented by the days-versus-depth chart 200 of FIG. 2. The days-versus-depth chart 600 also shows locations (in measured depth and time) at which mud motor stall events were identified according to the present techniques, as illustrated through circular markings 604.

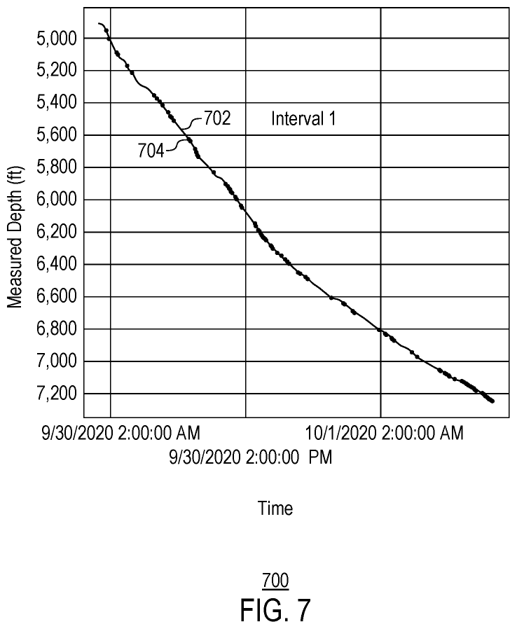

FIG. 7 is an exemplary days-versus-depth chart 700 for an interval of drilling, which is referred to as Interval 1, in accordance with the present techniques. This interval is taken from a subset of the data that were used for FIGS. 2 and 5. The days-versus-depth chart 700 includes hole depth (in feet) as a function of time, as shown at 702, as well as identified mud motor stall event locations, as illustrated through circular markings 704.

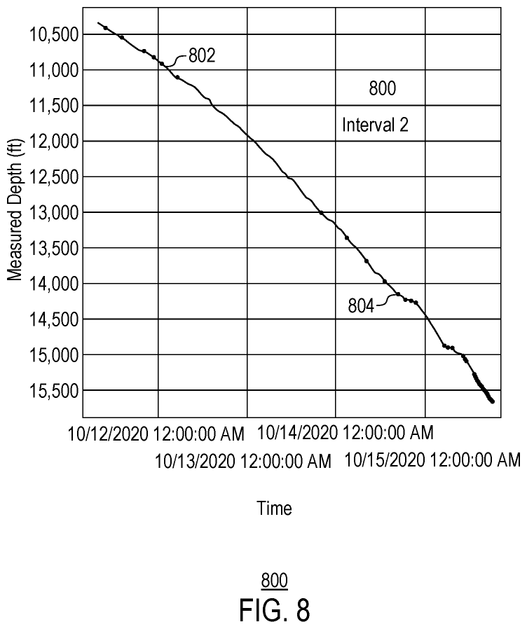

FIG. 8 is another exemplary days-versus-depth chart 800 for another interval of drilling, which is referred to as Interval 2, in accordance with the present techniques. This interval is also taken from a subset of the data that were used for FIGS. 2 and 6, where such subset is non-overlapping with the subset used for Interval 1. Similarly to the days-versus-depth chart 700 of FIG. 7, the days-versus-depth chart 800 of FIG. 8 includes hole depth (in feet) as a function of time, as shown at 802, as well as identified mud motor stall event locations, as illustrated through circular markings 804. Notably, the data utilized for Interval 1 and Interval 2 are relevant for many of the exemplary embodiments described below.

According to embodiments described herein, a pressure fluctuation distribution dataset, X, is determined using a subset of the calculated pressure fluctuation signal values, P_{fluct,j}. For example, if X̅ is a pressure fluctuation distribution dataset that contains all P_{fluct,j} values obtained according to the present techniques, then X⊂X̅. The distribution X need not contain a contiguous set of P_{fluct,j} values. For example, in some embodiments, X may contain only P_{fluct,j} for time values where the drill bit is on-bottom and drill string rotation is applied at the surface. In other embodiments, the set X contains only bit on-bottom data when WOB is greater than 20 klbs. Moreover, those skilled in the art will appreciate that a number of other embodiments are also applicable.

Using the present techniques, mud motor stall events may be identified using a pressure fluctuation distribution dataset X, a set of statistical values obtained by performing calculations on data from X, and parameter values that characterize a theoretical probability distribution function, where the parameter values are calculated using data from X. The present techniques may be used to determine a mud motor stall event value SE or a time-based signal of values SEⱼ. The stall event value or signal may be represented in a number of different ways. In some embodiments, the SEⱼ signal is represented using Boolean values as shown in equation (Eq. 5).

$${SE}_{j} = \{ \begin{matrix}True : if a mud motor stall is identified at time {t}_{j} \\ False : otherwise\end{matrix} \qquad ( Eq . 5 )$$

For drilling operations that are carried out using relatively steady control system set points (e.g., steady WOB, RPM, and ROP) in homogenous lithological formations, a distribution X can be evaluated for a set of P_{fluct,j} values. Under such ideal drilling conditions, the distribution X may be closely approximated by parameters that characterize a theoretical population distribution Y. There are a number of theoretical population distributions that may be considered for Y, with one of the simplest examples being a “normal” (or Gaussian) distribution. However, the techniques described herein are not limited to the use of only normal distributions for Y.

Next, a time interval of drilling during which a number of mud motor stall events occur, control system set points are steady, and formation lithology is homogeneous may be identified. A sample population X may be identified from the interval, and a theoretical population distribution Y may be introduced (once again constructed using data from X). For the present techniques, methods are used to construct Y so as to closely approximate X, except for regions in the distribution of X that contain mud motor stall events. For example, if mud motor stalls are known to exist in a given X, e.g., primarily above a certain percentile value, such as α=99%, then Y is constructed such that Y approximates the distribution of X for α∈(0, 0.99). Unfortunately, the percentile value above which mud motor stall events exist in X is not typically known from the outset. For the present techniques, methods are used to identify points in X that pertain to mud motor stall events. Such methods may also be applied to more general drilling conditions (e.g., non-stationary control system set points, varying subterranean formations and the presence of mud motor stall events).

As described herein, according to current techniques, mud motor stall events are identified by comparing calculated, potential mud motor stall event data to stored, historical mud motor stall event data. In contrast, according to the present techniques, mud motor stall events are identified without such data comparisons. This constitutes an advantage over current techniques, as mud motor stall events may be identified by applying the techniques described herein directly to any borehole drilling operation without necessitating the creation of catalogues of historical mud motor stall event data.

One means of identifying mud motor stall events from drilling data is via the analysis of “spikes” that occur in a pressure signal P. For example, in FIG. 5A, two very large differential pressure spikes occur between 4:40 AM and 4:45 AM. These spikes coincide with known mud motor stall events. According to the present techniques, P_{fluct,j}, X, and Y are used to robustly identify mud motor stall events using data of this nature.

In operation, drillers typically prescribe set point limits for pressure (e.g., P_{SP} and P_{Diff}) using control system software so that control systems will reduce parameters when actual pressures meet or exceed threshold values. The present techniques do not require driller-prescribed threshold values for pressures as inputs. The present techniques may be implemented using drilling sensor data as primary algorithm inputs.

Additional exemplary embodiments of the present techniques are provided in the following paragraphs. In such embodiments, the techniques described herein are used to determine X and X. In particular, X may be determined using a variety of techniques for capturing data from X that is pertinent to subsequent calculations. For example, in some embodiments, X is determined by filtering out data from X based on analysis of operational activities (e.g., on-bottom, off-bottom, sliding, rotating at surface, etc.), ranges for set point parameters, and formation characteristics.

In some embodiments, a theoretical normal distribution Y is constructed using all data from X except for data in certain lower and upper percentile ranges, such as, for example, 2%. In other embodiments, a normal distribution Y is constructed using all data from X.

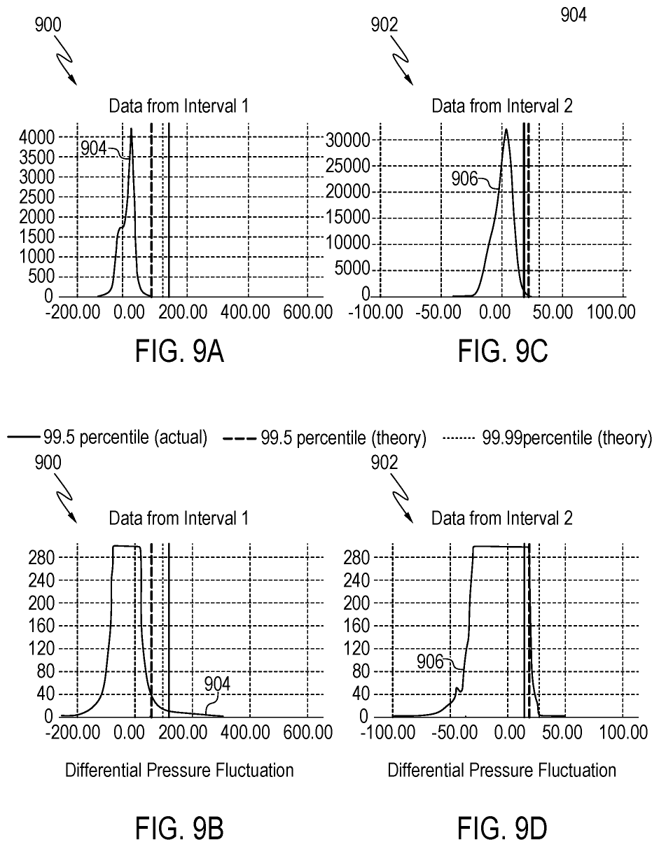

Data pertaining to an exemplary embodiment are illustrated in FIG. 9. Specifically, FIG. 9A is a histogram representation 900 of a distribution of differential pressure fluctuation data for an interval of drilling time for a drilled wellbore, where the interval is labeled as Interval 1, as described with respect to FIG. 7, in accordance with the present techniques. FIG. 9B is a zoomed-in view of the histogram representation 900 of FIG. 9A in accordance with the present techniques. FIG. 9C is a histogram representation 902 of a distribution of differential pressure fluctuation data for an interval of drilling time for a drilled wellbore, where the interval is labeled as Interval 2, as described with respect to FIG. 8 (and where the data are from the same wellbore as the data shown in FIGS. 9A and 9B and are non-overlapping with the data used for Interval 1), in accordance with the present techniques. FIG. 9D is a zoomed-in view of the histogram representation 902 of FIG. 9C in accordance with the present techniques.

More specifically, FIGS. 9A, 9B, 9C, and 9D show two different non-normalized pressure fluctuation distribution datasets X₁, as shown at 904, and X₂, as shown at 906, taken from data from Intervals 1 and 2, respectively. The distributions are depicted in FIGS. 9A, 9B, 9C, and 9D using histograms, where data has been binned and the y-axis represents the count per bin. Standard deviations S₁ and S₂ may be calculated for each distribution.

Each chart in FIGS. 9A, 9B, 9C, and 9D show lines for a set of statistical values for distributions X₁ and X₂. In particular, each chart shows lines for the following statistical values: a pressure fluctuation value P_{99.5} for the 99.5 percentile of the distribution, as well as theoretical pressure fluctuation values P_{theory,99.5} and P_{theory,99.99} for percentile values 99.5 and 99.99, respectively. The quantities P_{theory,99.5} and P_{theory,99.99} were obtained using theoretical formulas for theoretical normal distributions Y₁ and Y₂. These theoretical normal distributions were constructed using the respective mean values and the standard deviations S₁ and S₂ from X₁ and X₂, respectively.

For a theoretical normal distribution with a mean value μ=0, a standard deviation parameter S is sufficient for characterizing the normalized (area under the curve equals 1.0) normal distribution. In the general case, a “normal” distribution may be modeled using the probability density function p(x) shown in equation (Eq. 6).

$$p ( x ) = \frac{1}{S \sqrt{2 π}} exp [ - \frac{1}{2} {( \frac{x - μ}{S} )}^{2} ] \qquad ( Eq . 6 )$$

In equation (Eq. 6), x is a point in Y. Note that the above expression reduces to the expression shown in equation (Eq. 7) when the population mean μ=0.

$$p ( x ) = \frac{1}{S \sqrt{2 π}} exp [ - \frac{1}{2} {( \frac{x}{S} )}^{2} ] \qquad ( Eq . 7 )$$

However, the present techniques are not restricted to the use of a normal distribution to characterize Y. Any number of other theoretical distributions may be considered by those skilled in the art. A few additional non-limiting examples include the Chi distribution, the Fréchet distribution, the Poisson distribution, and the Dagum distribution.

In a continuation of the above exemplary embodiment of the present techniques, mud motor stall events are identified as occurring whenever a calculated pressure fluctuation signal value, P_{fluct,j}, is greater than P_{99.5} and P_{theory,99.99} (note that in the general case, P_{α}∈X and P_{theory,β}∈Y) for prescribed percentile values α and β. In another exemplary embodiment, mud motor stall events are identified as occurring whenever a calculated pressure fluctuation signal value, P_{fluct,j}, is greater than P_{99.5} and P_{theory,99.99} or when at least m contiguous values P_{fluct,j}, are greater than P_{99.5} and P_{theory,99.5}, where m>1 is a user-prescribed value. In a more specific example, m is prescribed to be equal to 3.

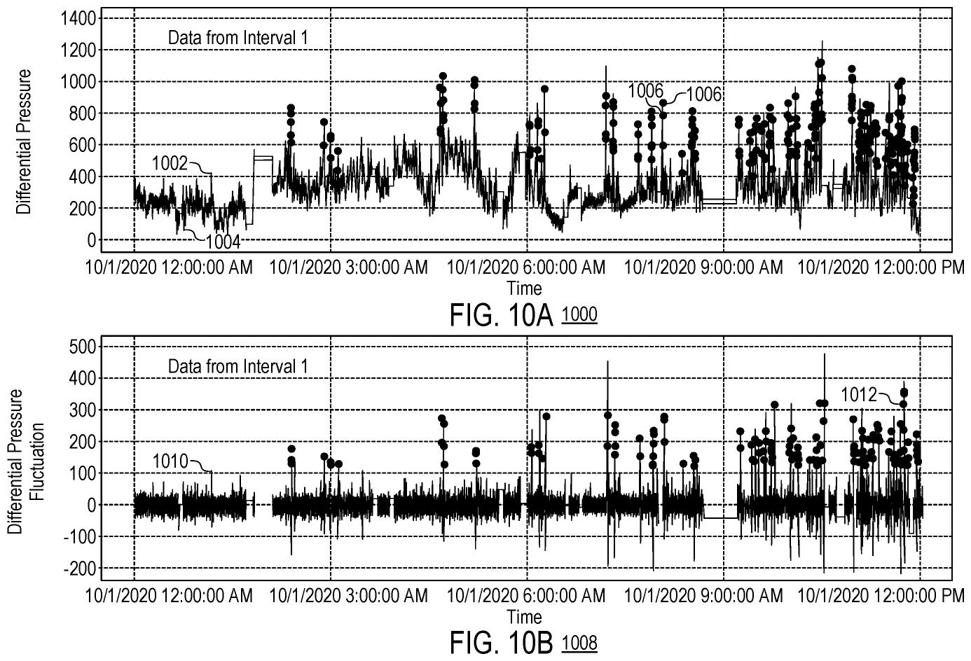

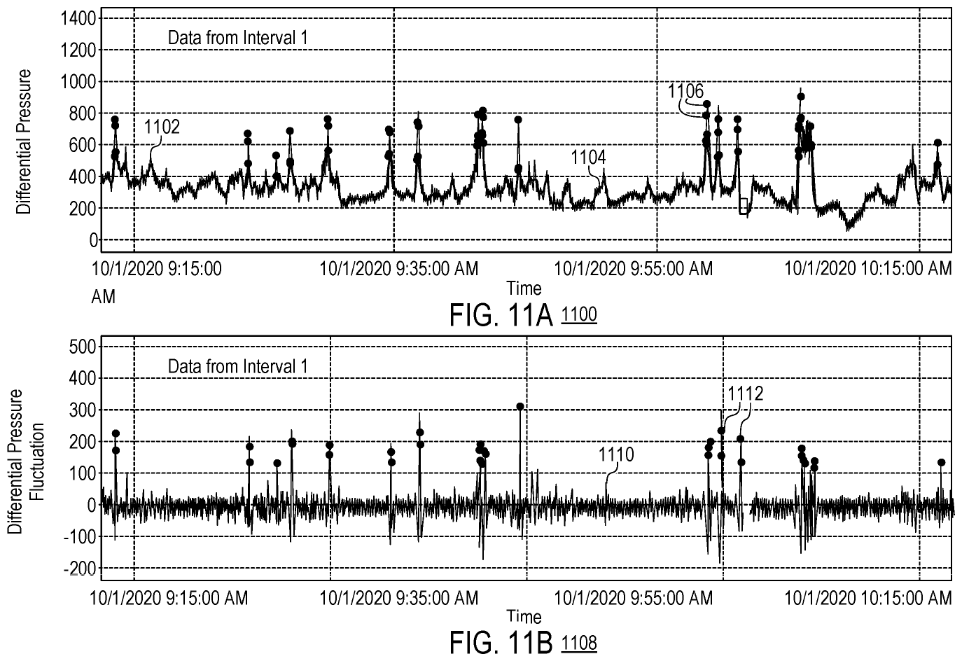

Results from an exemplary embodiment of the techniques described herein are shown in FIGS. 10A and 10B. For this exemplary embodiment, the method 300 described with respect to FIG. 3A has been utilized. Specifically, FIG. 10A is a graph 1000 including traces of a measured differential pressure signal P=P_{Diff} versus time, as shown at 1002, and a calculated average differential pressure signal versus time, as shown at 1004, for a subset of data from Interval 1, where such subset is taken from 12 hours of on-bottom drilling data from Interval 1, as described with respect to FIG. 7, in accordance with the present techniques. Calculated mud motor stall events, as identified using an exemplary method of the present techniques, are illustrated through circular markings 1006. Similarly, FIG. 10B is graph 1008 including traces of a calculated differential pressure fluctuation signal, P_{fluct}, versus time, as shown at 1010, as well as calculated mud motor stall events, as illustrated through circular markings 1012, for the subset of data from Interval 1, in accordance with the present techniques.

FIGS. 11A and 11B illustrate a 1-hour zoomed-in view of a portion of the data shown in FIGS. 10A and 10B. Specifically, FIG. 11A is a graph 1100 including traces of a measured differential pressure signal versus time, as shown at 1102, and a calculated average differential pressure signal versus time, as shown at 1104, for a subset of data from Interval 1 in accordance with the present techniques. Calculated mud motor stall events, as identified using an exemplary method of the present techniques, are illustrated through circular markings 1106. Relatedly, FIG. 11B is a graph 1108 including traces of a calculated differential pressure fluctuation signal, P_{fluct}, versus time, as shown at 1110, as well as calculated mud motor stall events, as illustrated through circular markings 1112, for the subset of data from Interval 1 in accordance with the present techniques.

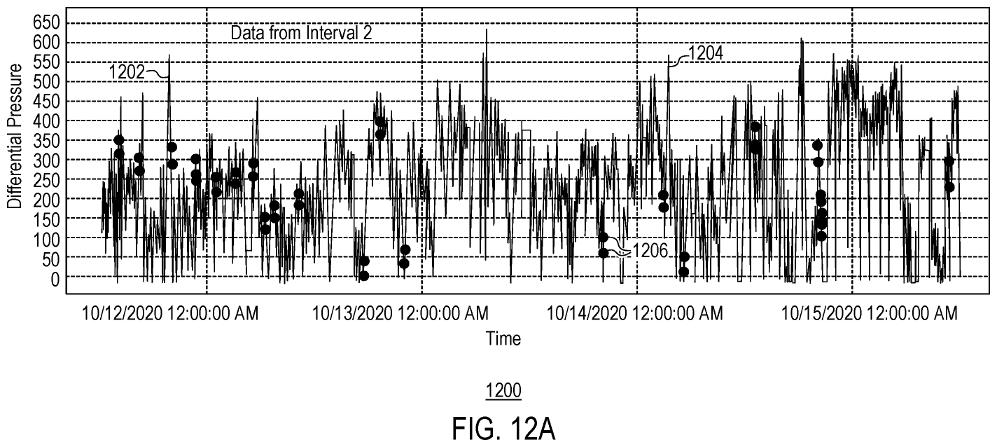

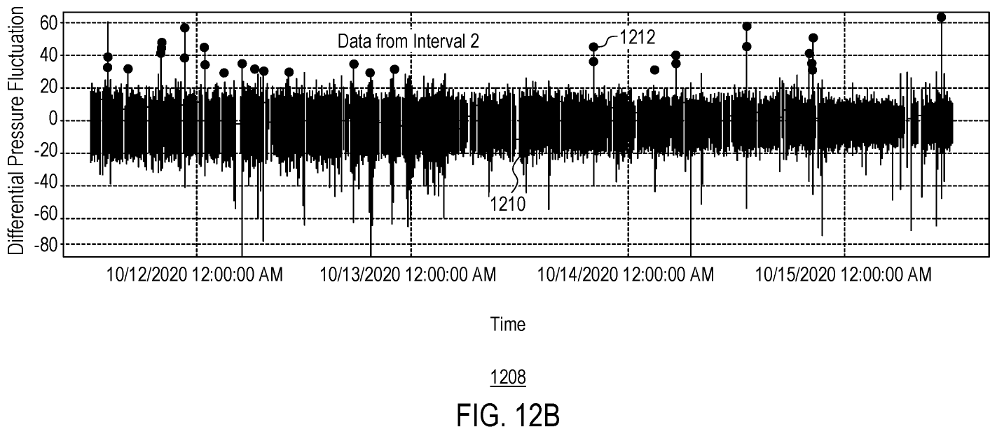

Results from another exemplary embodiment of the techniques described herein are shown in FIGS. 12A and 12B. For this exemplary embodiment, the method 318 described with respect to FIG. 3B has been utilized. FIG. 12A is a graph 1200 including traces of a measured differential pressure signal versus time, as shown at 1202, and a calculated average differential pressure signal versus time, as shown at 1204, for a subset of data from Interval 2 in accordance with the present techniques. Calculated mud motor stall events, as identified using an exemplary method of the present techniques, are illustrated through circular markings 1206. FIG. 12B is a graph 1208 including traces of a calculated differential pressure fluctuation signal, P_{fluct}, versus time, as shown at 1210, as well as calculated mud motor stall events, as illustrated through circular markings 1212, for the subset of data from Interval 2 in accordance with the present techniques.

For this exemplary embodiment, a large portion (e.g., about three days duration) of differential pressure and differential pressure fluctuation data were analyzed to identify mud motor stall events, where such data include a large subset of the data from Interval 2. Moreover, for this exemplary embodiment, windowed distributions, X, of differential pressure fluctuation data were used in the analysis, where each windowed distribution contains 6 hours of bit on-bottom drilling data. For each distribution, a set of statistical values has been calculated, including (but not limited to) a standard deviation, S; a set {P_{α}} of differential pressure fluctuation values for a set of percentile values, {αᵢ}; and a set {P_{theory,α}} of theoretical differential pressure fluctuation values, also using {αᵢ}. In this exemplary embodiment, {αᵢ}={98.5%, 99%, 99.25%, 99.99%}. The calculated statistical values for the multiple windowed distributions were utilized to calculate a normal distribution, Y, for each X.

For this exemplary embodiment, a pressure cutoff, P_{cutoff}, was determined for each 6-hour dataset, X, using the following criteria: P_{cutoff}=max[P_{99.5}, P_{theory,99.99}] (where max represents the maximum value operator). A time-dependent P_{cutoff} signal was calculated using each P_{cutoff} value for each 6-hour dataset via median filtering signal processing techniques. The P_{cutoff} signal was then used as the basis for identifying mud motor stalls via the criteria shown in equation (Eq. 8).

$${SE}_{j} = True if {P}_{fluct , j} > {P}_{cutoff} ( {t}_{j} ) , otherwise False \qquad ( Eq . 8 )$$

In equation (Eq. 8), SEⱼ=True implies positive identification of a mud motor stall event at time tⱼ. In the exemplary embodiment illustrated by FIGS. 12A and 12B, mud motor stall events were identified to have occurred at a lower frequency than for the exemplary embodiment illustrated by FIGS. 10A and 10B (where 12 hours of data are shown in this figure). Correspondingly, the mud motor is subjected to less damage in Interval 2 (e.g., as shown in FIG. 12) than in Interval 1 (e.g., as shown in FIG. 10). Furthermore, the drilling assembly used to drill Interval 2 was able to drill substantially more footage prior to tripping out of the hole as compared to the drilling assembly used to drill Interval 1.

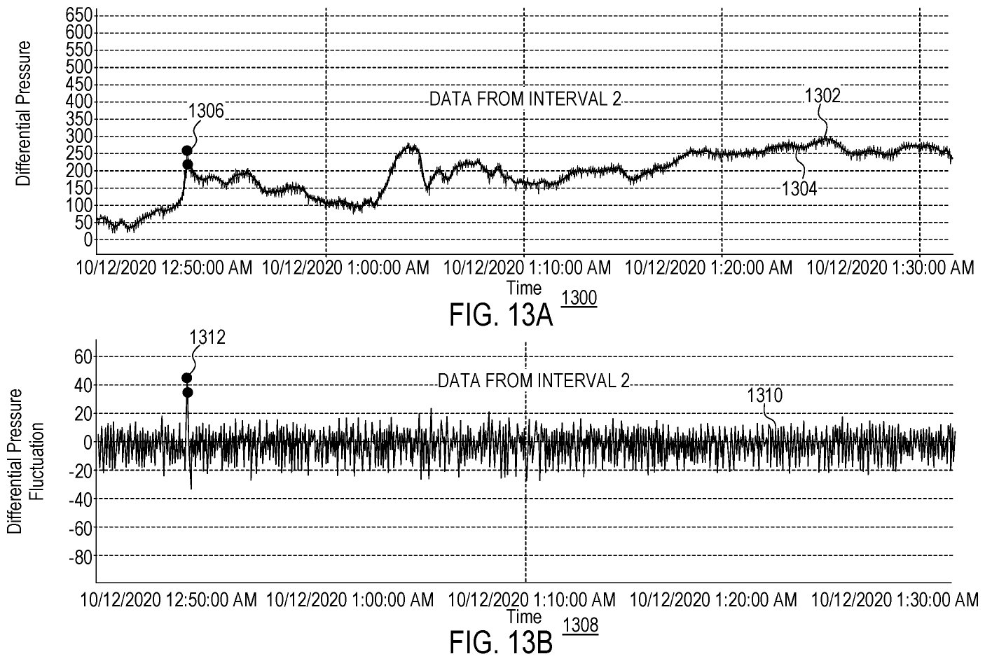

FIGS. 13A and 13B illustrate a zoomed-in view of portion of the data shown in FIGS. 12A and 12B. Specifically, FIG. 13A is a graph 1300 including traces of a measured differential pressure signal versus time, as shown at 1302, and a calculated average differential pressure signal versus time, as shown at 1304, for a subset of data from Interval 2 in accordance with the present techniques. Calculated mud motor stall events, as identified using an exemplary method of the present techniques, are illustrated through circular markings 1306. FIG. 13B is a graph 1308 including traces of a calculated differential pressure fluctuation signal, P_{fluct}, versus time, as shown at 1310, as well as calculated mud motor stall events, as illustrated through circular markings 1312, for the subset of data from Interval 2 in accordance with the present techniques. As shown in FIGS. 13A and 13B, the 40-minute windowed dataset shows a single cluster of data points, at around 12:50 AM, where mud motor stalling was identified.

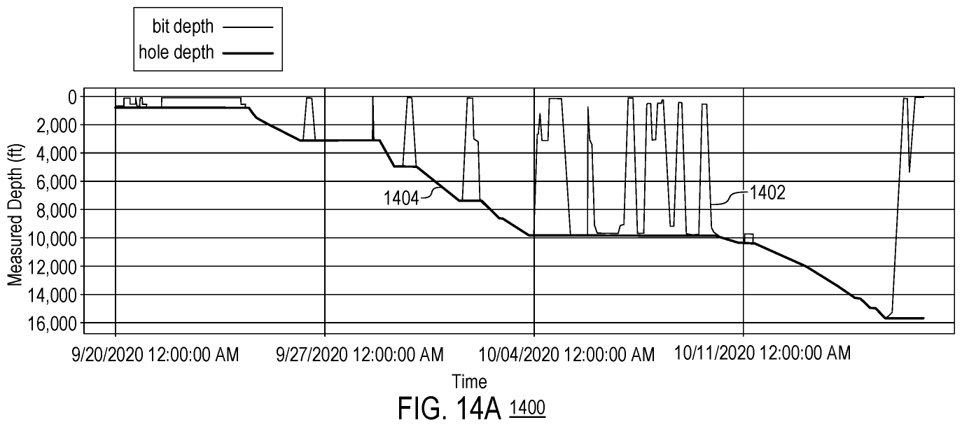

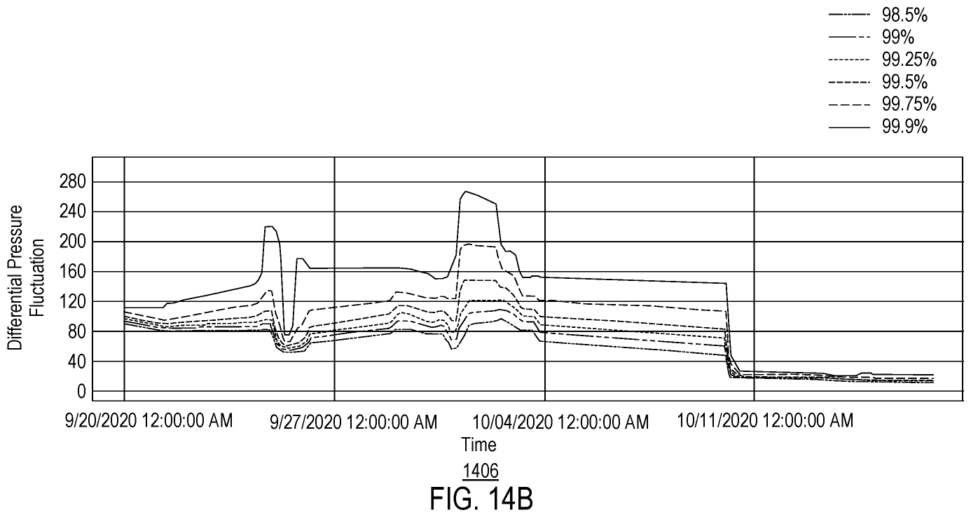

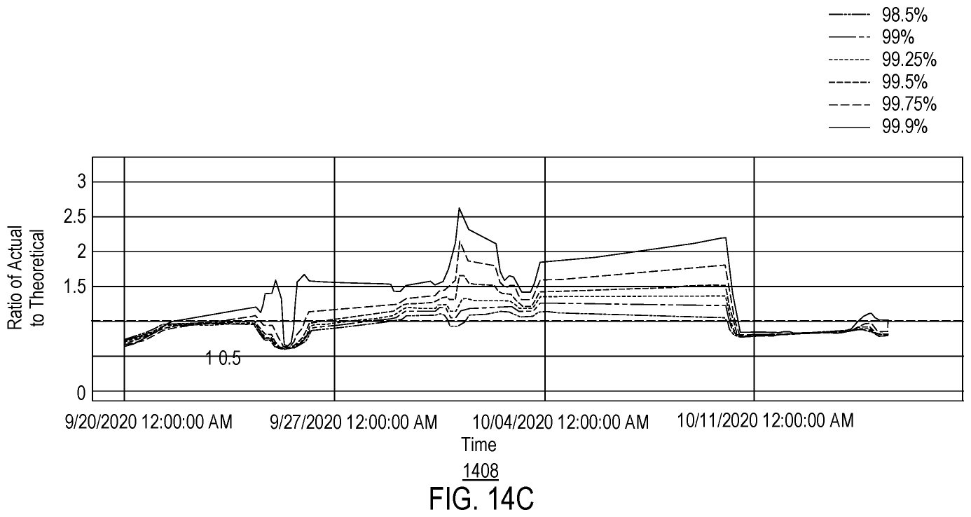

In another exemplary embodiment of the present techniques, the method 318 of FIG. 3B is used to identify mud motor stall events. For this exemplary embodiment, the techniques described herein are used to compute a set of statistical values for multiple time-windowed differential pressure data distributions X. For each distribution, the calculated statistics obtained by performing data analysis on the distribution include (but are not limited to) a standard deviation, S; multiple pressure fluctuation values, {P_{α}}, for multiple selected percentile values, {αᵢ}; and probability distribution parameters that characterize a theoretical normal probability distribution, Y (using all data from each X). Signal analysis techniques are then applied to calculate time-dependent signals for each statistical parameter. Results for a specific example applied to an entire well are shown in FIGS. 14A, 14B, and 14C. This well is the same well that has been used in the previously-described examples. FIG. 14A is an exemplary days-versus-depth chart 1400 that is based on data obtained from a drilled wellbore in accordance with the present techniques. Specifically, the days-versus-depth chart 1400 provides traces of drill bit depth as a function of time, as shown at 1402, and hole depth as a function of time, as shown at 1404. FIG. 14B is a graph 1406 showing traces of calculated differential pressure fluctuation signals, {P_{α}}, versus time for the following selected percentile values: {αᵢ}: 98.5%, 99%, 99.25%, 99.5%, 99.75% and 99.9%, in accordance with the present techniques. These traces were determined using an exemplary method of the present techniques. In particular, each signal shown in FIG. 14B was computed using statistical values from each distribution, X, as a function of time. Each distribution X contained approximately 4 hours of on-bottom drilling. Furthermore statistical values of distributions were at a period of about 1 hour (of on-bottom drilling). As in the prior example, median filtering was applied to smoothen the resulting statistics and generate the time-based statistical signals shown in FIG. 14B. Although not shown in FIG. 14B, a differential pressure fluctuation standard deviation signal, S, was also computed in the analysis using the same techniques described above. Although data is calculated only when the bit is on bottom, the plotting software displays continuous lines including when the bit is off bottom.

FIG. 14C is a graph 1408 showing ratio traces, R_{α}(t), between the calculated differential pressure fluctuation signals, {P_{α}}, and the theoretical differential pressure fluctuation signals, {P_{theory,α}}, versus time for the following selected percentile values: 98.5%, 99%, 99.25%, 99.5%, 99.75% and 99.9%, in accordance with the present techniques. These traces were determined using an exemplary method of the present techniques. Each trace shown in FIG. 14C shows a computed ratio, R_{α}(t), defined as shown in equation (Eq. 9) for each selected percentile α.

$${R}_{α} ( t ) = {P}_{α} ( t ) / {P}_{theory , α} ( t ) \qquad ( Eq . 9 )$$

As shown in FIG. 14C, the graph 1408 includes traces for R_{98.5%}, R_{99%}, R_{99.25%}, R_{99.5%}, R_{99.75%}, and R_{99.9%}. In this example, theoretical normal distributions were used to calculate {P_{theory,α}}. Moreover, if the actual differential pressure fluctuation distributions, X, had been “normal”, each trace in FIG. 14C would be nearly equal to 1.0.

Deviations of R_{α}(t) from a value of 1.0 may be used to estimate the extent to which an actual distribution, e.g., X, deviates from a theoretical “normal” distribution, Y. For example, R_{α}(t)<1 indicates that P_{α} is closer to the mean in X than one would expect for the theoretical normal distribution, Y. When R_{α}(t)>1, this indicates that P_{α} is farther away from the mean than would be expected for the theoretical normal distribution, Y. Moreover, although normal distributions have been used in this example, those skilled in the art will appreciate that other distributions may alternatively be used to carry out the present techniques.

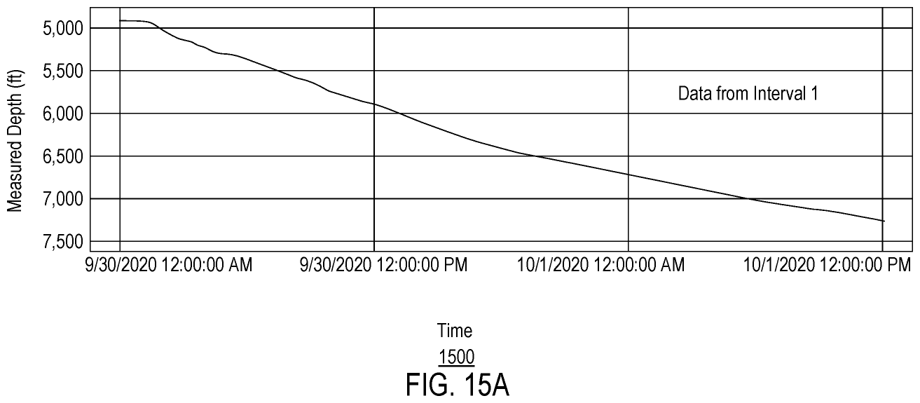

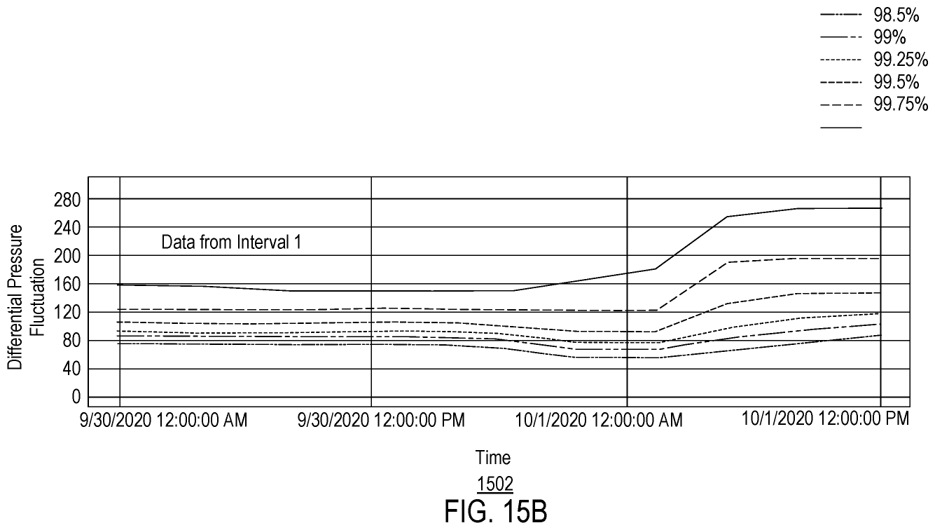

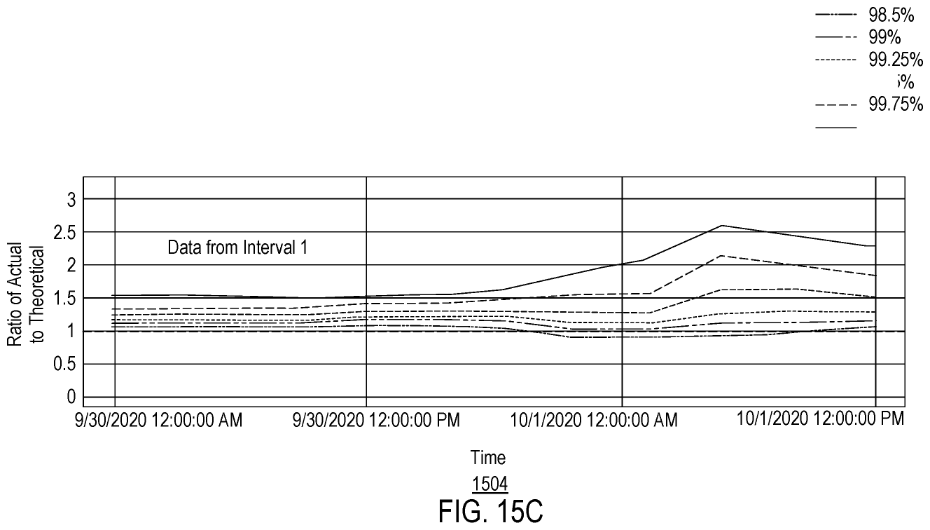

In a continuation of the example embodiment above, R_{α}(t) signals are used in the process of identifying mud motor stall events. For example, FIGS. 15A, 15B, and 15C include a zoomed-in view of data from FIGS. 14A, 14B, and 14C. In particular, FIG. 15A is a days-versus-depth chart 1500 for a subset of data from Interval 1 in accordance with the present techniques. This figure provides traces of drill bit depth and hole depth as a function of time. FIG. 15B is a graph 1502 showing traces of calculated differential pressure fluctuation values versus time for the following selected percentile values: 98.5%, 99%, 99.25%, 99.5%, 99.75% and 99.9%, in accordance with the present techniques. These traces were determined using an exemplary method of the present techniques. FIG. 15C is a graph 1504 showing ratio traces between the calculated differential pressure fluctuation signals and the theoretical differential pressure fluctuation signals versus time for the following selected percentile values: 98.5%, 99%, 99.25%, 99.5%, 99.75% and 99.9%, in accordance with the present techniques. These traces were determined using an exemplary method of the present techniques.

The data shown in FIGS. 15A, 15B, and 15C are for Interval 1, and all R_{α}(t) signals shown are found to be greater than 1 for the majority of the elapsed time. Many of these signals, and especially the most upper percentile signals, grow in magnitude after 6 pm on September 30th. In some embodiments, a selected number of these signals, e.g., R_{99.5%}(t) and R_{99.75%}(t), may be displayed to drilling personnel while drilling. Drillers may then use the signals to trend mud motor stall events over time. These signals will grow when more frequent and more severe stall events occur over time. These signals will likewise reduce when stall events are less frequent and less severe. The data shown in FIG. 10A may be compared with the trends shown in FIG. 15C to confirm this behavior for R_{α}(t). Drillers may respond to trends in R_{99.5%}(t) and R_{99.75%}(t) through adjustments to drilling practices as a means of reducing occurrences of mud motor stalling. Such reductions will be reflected in the R_{99.5%}(t) and R_{99.75%}(t) signals. Exemplary steps associated with carrying out this embodiment are provided with respect to the method 400 of FIG. 4.

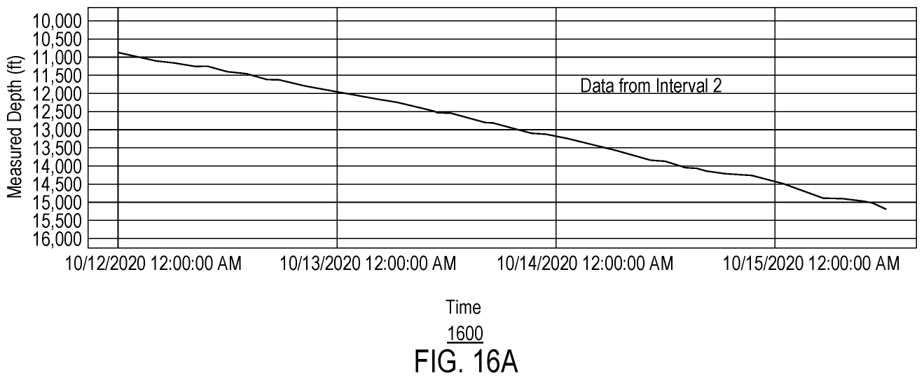

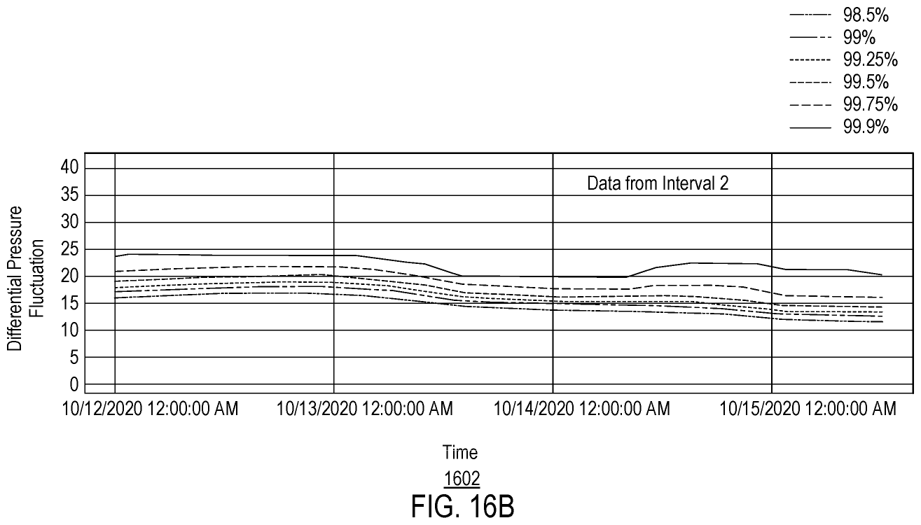

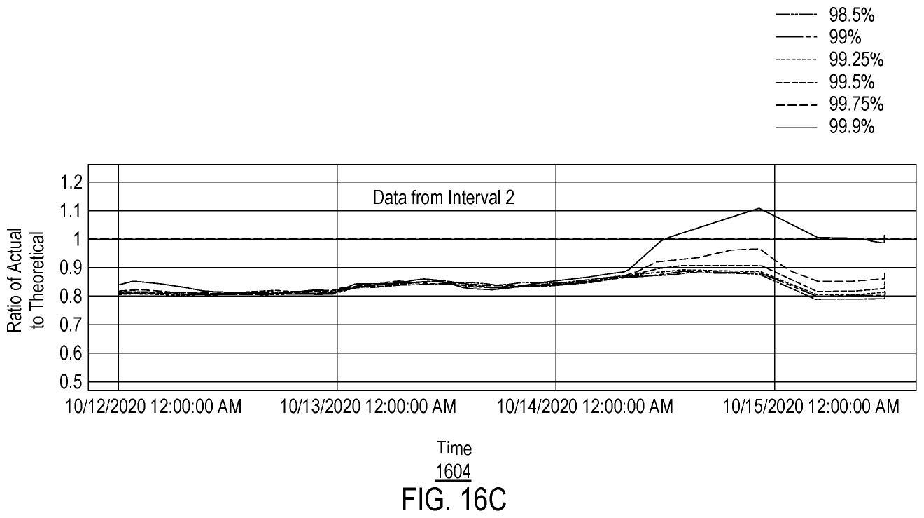

FIGS. 16A, 16B, and 16C includes a zoomed in view of data from FIGS. 14A, 14B, and 14C. Specifically, FIG. 16A is a days-versus-depth chart 1600 for a subset of data from Interval 2 in accordance with the present techniques. FIG. 16B is a graph 1602 showing traces of calculated differential pressure fluctuation values versus time for the following selected percentile values: 98.5%, 99%, 99.25%, 99.5%, 99.75% and 99.9%, in accordance with the present techniques. These traces were determined using an exemplary method of the present techniques. FIG. 16C is a graph 1604 showing ratio traces between the calculated differential pressure fluctuation signals and the theoretical differential pressure fluctuation signals versus time for the following selected percentile values: 98.5%, 99%, 99.25%, 99.5%, 99.75% and 99.9%, in accordance with the present techniques. These traces were determined using an exemplary method of the present techniques.

The data shown in FIGS. 16A, 16B, and 16C are from a subset of Interval 2, and all R_{α}(t) signals are less than 1 for the majority of the time. In a continuation of the embodiment described above, drillers may use these signal values to infer that there are very few mud motor stall events present during this period of time. Use of R_{α}(t) signals is not required in this embodiment. Selected P_{α} signals or other equivalent signals may also be used.

Frequent occurrences of mud motor stalling and elevated values for R_{α}(t) may also be used to infer information about the health of a mud motor. For example, a damaged mud motor may exhibit more frequent and/or more severe stall events than an undamaged mud motor for the same drilling conditions. In some embodiments, R_{α}(t) signals for a selected set of percentiles {αᵢ} are calculated and displayed while drilling. These signals may be used to assess the cumulative severity of mud motor damage over time and to inform decisions for optimal time to trip out of hole to change out the mud motor from the drill string. For example, if drilling personnel are unable to sufficiently reduce R_{α}(t) values by implementing changes to the drilling operation, the R_{α}(t) signals may provide an indication that the mud motor or other downhole tools may be damaged. Notably, the use of the R_{α}(t) signals is not required to carry out this embodiment. Selected P_{α} signals or other equivalent signals may also be used.

In some of the embodiments described above, the statistical quantities used to establish thresholds, e.g., P_{cutoff} values, for identifying mud motor stall events were specified. However, the present techniques are much more general and include techniques for algorithmically determining criteria for setting P_{cutoff} values to be used to identify mud motor stall events. For example, see FIG. 3B and, in particular, block 332. In an exemplary embodiment, a computer-implemented method uses the techniques described above to compute R_{α}(t) signals for a set of selected percentile values, {αᵢ}, using theoretical normal distributions for each Y (without excluding data from X when constructing Y). Without loss of generality, the time t is fixed, and the R_{α}(t) signals are represented using the slightly-modified notation shown in equation (Eq. 10).

$$R ( s ; t ) ≡ {R}_{α ( s )} ( t ) \qquad ( Eq . 10 )$$

In equation (Eq. 10), α is expressed as a function of the “standard score,” s, for a calculated theoretical distribution, Y. Formally, s is defined as shown in equation (Eq. 11), where x∈Y.

$$s ≡ x / S \qquad ( Eq . 11 )$$

Those skilled in the art of statistics are aware of the well-known formulas that relate s to α for normal distributions. In equation (Eq. 10), the notation R(s;t) has been introduced to aid the discussion which follows.

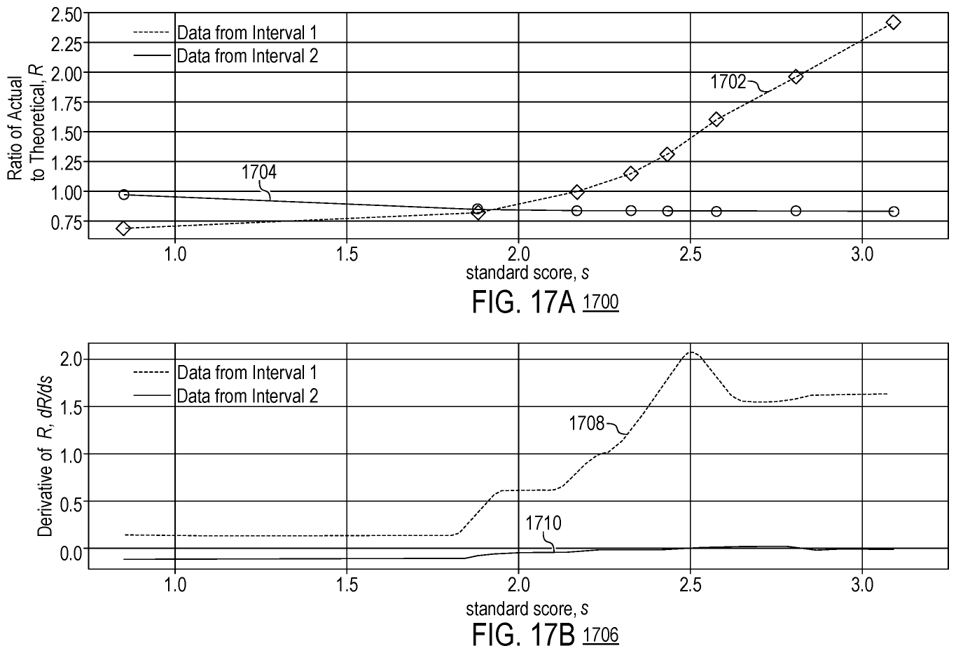

FIG. 17A is a graph 1700 showing ratio traces, R(s;t), between the calculated differential pressure fluctuation signals and the theoretical differential pressure fluctuation signals versus time for a normal distribution, as a function of standard score s and time t, in accordance with the present techniques. Two populations are presented in this figure for datasets from Intervals 1 and 2, where a first trace 1702 is taken from a point in time during Interval 1 and a second trace 1704 is likewise taken from a point in time during Interval 2.

FIG. 17B is a graph 1706 showing traces of derivatives of the traces found in FIG. 17A, with respect to the standard score s, in accordance with the present techniques. In the figure, traces of dR/ds, i.e., derivatives of R(s;t) with respect to s, are plotted. A first trace 1708 in FIG. 17B is the derivative of the first trace 1702 from FIG. 17A, and a second trace 1710 in FIG. 17B is the derivative of the second trace 1704 from FIG. 17A.

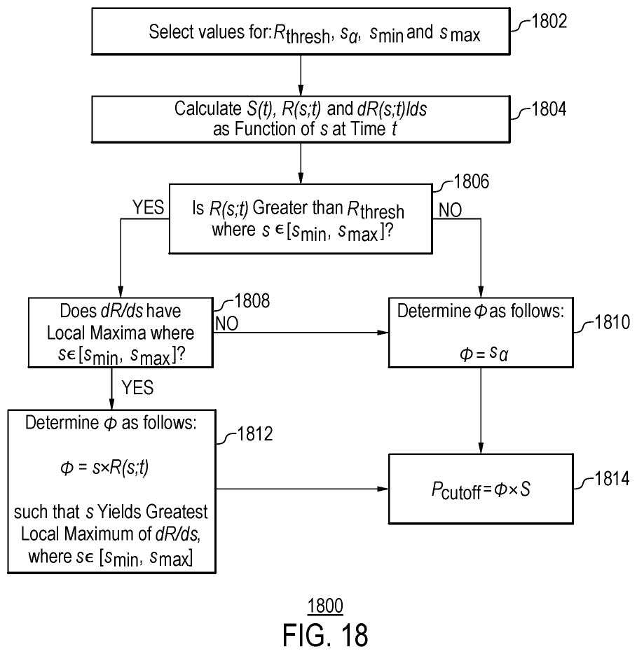

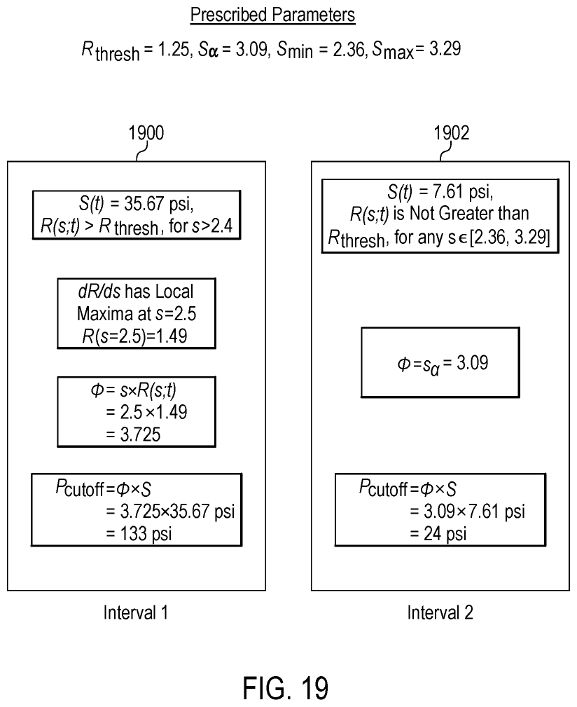

In various embodiments, the present techniques utilize characteristics of R(s;t) to determine a pressure cutoff threshold, P_{cutoff}, to be used to identify mud motor stalling. A non-limiting exemplary embodiment is shown in FIG. 18, where FIG. 18 is a process flow diagram of a method 1800 for determining a P_{cutoff} value that can be used to identify mud motor stall events in accordance with the present techniques. For this method 1800, the user prescribes four input values, as shown in block 1802, and then carries out any of blocks 1804, 1806, 1808, 1810, and 1812 to arrive at a value for P_{cutoff} at block 1814. In the exemplary embodiment shown in FIG. 18, the following values are used for the parameters listed in block 1802:
Rₜₕᵣₑₛₕ=1.25 (a threshold value that will be compared to an R_{α}(t))
s_{α}=3.09 (s value for α=99.9% for a normal distribution).
sₘᵢₙ=2.36 (s value for α=99% for a normal distribution).
sₘₐₓ=3.29 (s value for α=99.95% for a normal distribution).

At block 1804, S(t), R(s;t), and dR(s;t)/ds are calculated as a function of s at time t. At block 1806, a determination is made about whether R(s;t) is greater than Rₜₕᵣₑₛₕ, where s∈[sₘᵢₙ,sₘₐₓ]. If the answer is “yes,” the method 1800 proceeds to block 1808, at which a determination is made about whether dR/ds has a local maxima where ∈[sₘᵢₙ,sₘₐₓ]. If the answer is “no” at either block 1806 or block 1808, the method 1800 proceeds to block 1810, at which ø is determined as follows: ϕ=s_{α}. If the answer is “yes” at block 1808, the method 1800 proceeds to block 1812, at which ϕ is determined as follows: ϕ=s×R(s;t), such that s yields the greatest local maximum of dR/ds, where s∈[sₘᵢₙ,sₘₐₓ]. From block 1810 or block 1812, the method 1800 proceeds to block 1814, at which P_{cutoff} is determined as follows: P_{cutoff}=ϕ×s. (See FIG. 3B and, in particular, block 332 for an example of how the P_{cutoff} value may then be utilized for some embodiments of the present techniques.)

FIG. 19 provides an example of the manner in which the method 1800 of FIG. 18 might be used to carry out an embodiment of the present techniques for data from Interval 1, as shown at 1900, and data from Interval 2, as shown at 1902, in accordance with the present techniques. In this example, the R(s;t) curves shown in FIG. 17A are calculated. The derivative of these curves are also considered with respect to s, as shown in FIG. 17B. The standard deviations of the pressure fluctuation signal for Interval 1 and Interval 2 are S=35.67 psi and S=7.61 psi, respectively. Calculations for P_{cutoff} values for Intervals 1 and 2, using the method 1800 of FIG. 18, are shown in FIG. 19. For Intervals 1 and 2, P_{cutoff} is determined to be 133 psi and 24 psi, respectively.

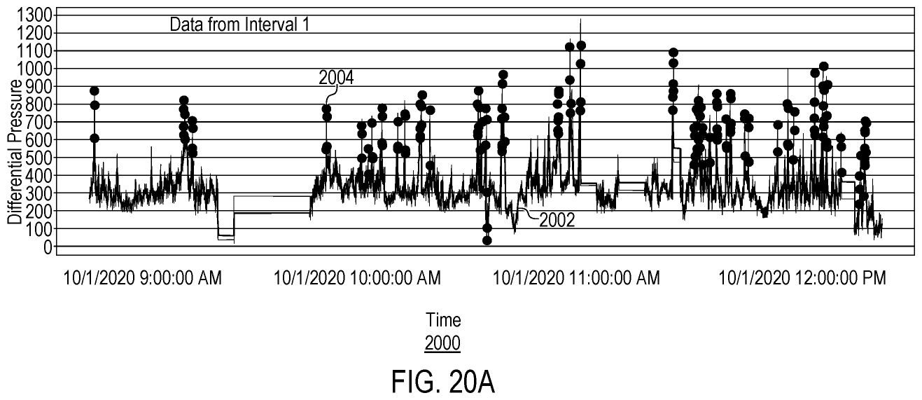

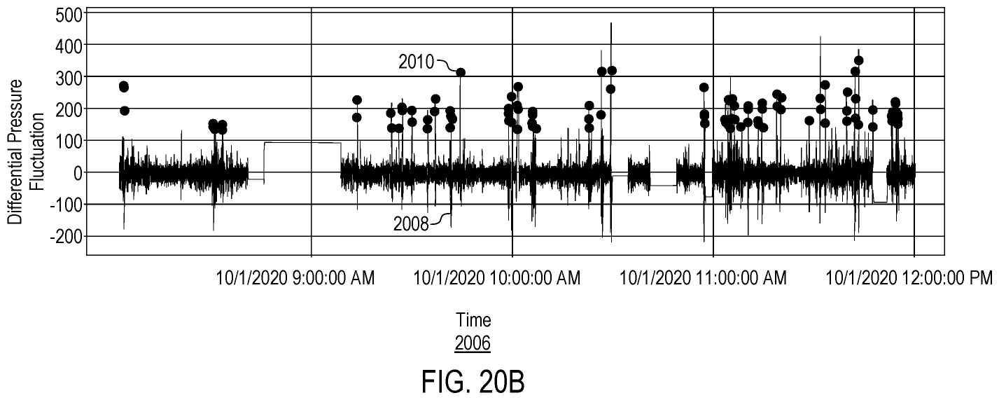

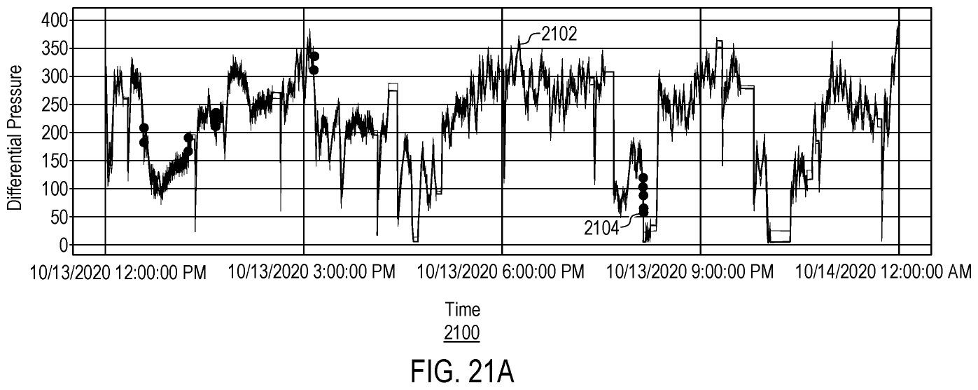

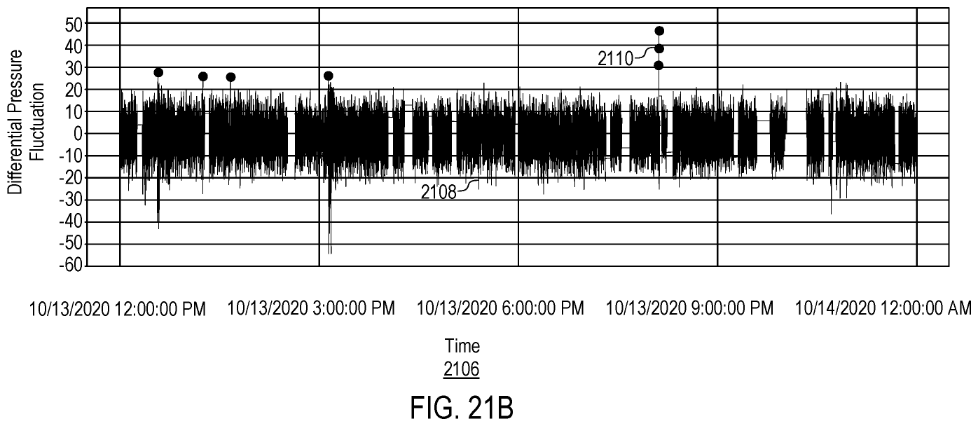

Mud motor stall events identified using these thresholds are shown in FIG. 20 (for Interval 1) and FIG. 21 (for Interval 2) for selected time windows. Specifically, FIG. 20A is a graph 2000 providing differential pressure traces, as shown at 2002, and identified mud motor stall events, as shown at 2004, for data from Interval 1 in accordance with the present techniques. FIG. 20B is a graph 2006 providing differential pressure fluctuation traces, as shown at 2008, and identified mud motor stall events, as shown at 2010, for data from Interval 1 in accordance with the present techniques. Similarly, FIG. 21A is a graph 2100 providing differential pressure traces, as shown at 2102, and identified mud motor stall events, as shown at 2104, for data from Interval 2 in accordance with the present techniques. FIG. 21B is a graph 2106 providing differential pressure fluctuation traces, as shown at 2108, and identified mud motor stall events, as shown at 2110, for data from Interval 2 in accordance with the present techniques. The present techniques successfully identify the majority of the large number of mud motor stall events that occurred for Interval 1 during the time-window shown in FIGS. 20A and 20B. When applied to data taken from the time-window from Interval 2, the present techniques identify very few mud motor stall events, as can be seen in FIGS. 21A and 21B. Although several of these identified mud motor stall events are likely “false positives,” the overall robustness of the present techniques should be evident. (Note that the time interval for FIGS. 21A and 21B is 36 hours.) Calibration and learning over time will help differentiate between false positives and true mud motor stall events.

The present techniques may be used to robustly identify mud motor stall events. Additional procedures utilizing data from identified stall events may be applied to quantify the severity of individual mud motor stall events and to produce metrics for quantifying the cumulative impact of such stall events on the mud motor. Individual stall severity metrics may be formulated using the magnitude of the differential pressure signal, the magnitude of the differential pressure fluctuation signal, the duration of a stall event, and/or the rate at which a stall occurs. Stall severity metrics may also utilize engineering parameters for a given mud motor and may further make use of energy methods (e.g., methods that quantify the energy or power associated with a mud motor stall). Cumulative stall severity metrics may combine stall severity metrics for individual mud motor stall events. Potential examples of cumulative metrics indicating motor damage include, but are not limited to, the total number of stalls, the frequency of stalls, the total energy of stalls, the cumulative time of stalls, the time-integrated excess of a P_{fluct} value over a P_{cutoff} value, and various statistics about stalls. An exemplary but non-limiting damage index may be written as shown in equation (Eq. 12).

$$Damage = \sum Δ t \cdot [ {P}_{fluct , j} - {P}_{cutoff} ( {t}_{j} ) ] \qquad ( Eq . 12 )$$

In some embodiments, the present techniques may be applied to any (or all) of the wellbores corresponding to a fleet of drilling rigs within a particular field. The results may then be utilized to determine mud motor stall trends that are common to the wellbores within the field. This, in turn, may enable the entire fleet to be managed in a manner that optimizes the performance of the mud motors within the field. Furthermore, in some embodiments, the present techniques may be used to determine one or more performance metrics corresponding to the drilling rigs within a particular fleet. For example, the present techniques may be used to compute a monthly metric of the number of mud motor stall events per drilling rig for the fleet. This performance metric may then be used to modify the operation of the drilling rigs within the field such that the number of mud motor stall events is minimized.

### Exemplary Cluster Computing System for Implementing Techniques Described Herein

FIG. 22 is a block diagram of an exemplary cluster computing system 2200 that may be utilized to implement mud motor stall event identification in accordance with the present techniques. The exemplary cluster computing system 2200 shown in FIG. 22 has four computing units 2202A, 2202B, 2202C, and 2202D, each of which may perform calculations for a portion of the mud motor stall event identification techniques described herein. However, one of ordinary skill in the art will recognize that the cluster computing system 2200 is not limited to this configuration, as any number of computing configurations may be selected. For example, a smaller analysis may be run on a single computing unit, such as a workstation, while a large calculation may be run on a cluster computing system 2200 having tens, hundreds, thousands, or even more computing units.

The cluster computing system 2200 may be accessed from any number of client systems 2204A and 2204B over a network 2206, for example, through a high-speed network interface 2208. The computing units 2202A to 2202D may also function as client systems, providing both local computing support and access to the wider cluster computing system 2200.

The network 2206 may include a local area network (LAN), a wide area network (WAN), the Internet, or any combinations thereof. Each client system 2204A and 2204B may include one or more non-transitory, computer-readable storage media for storing the computer-executable instructions that are used to implement the mud motor stall event identification techniques described herein. For example, each client system 2204A and 2204B may include a memory device 2210A and 2210B, which may include random access memory (RAM), read only memory (ROM), and the like. Each client system 2204A and 2204B may also include a storage device 2212A and 2212B, which may include any number of hard drives, optical drives, flash drives, or the like.

The high-speed network interface 2208 may be coupled to one or more buses in the cluster computing system 2200, such as a communications bus 2214. The communication bus 2214 may be used to communicate instructions and data from the high-speed network interface 2208 to a cluster storage system 2216 and to each of the computing units 2202A to 2202D in the cluster computing system 2200. The communications bus 2214 may also be used for communications among the computing units 2202A to 2202D and the cluster storage system 2216. In addition to the communications bus 2214, a high-speed bus 2218 can be present to increase the communications rate between the computing units 2202A to 2202D and/or the cluster storage system 2216.

The cluster storage system 2216 can have one or more non-transitory, computer-readable storage media, such as storage arrays 2220A, 2220B, 2220C and 2220D for the storage of models, data, visual representations, results (such as graphs, charts, and the like used to convey results obtained using the mud motor stall event identification techniques described herein), code, and other information concerning the implementation of the mud motor stall event identification techniques described herein. The storage arrays 2220A to 2220D may include any combinations of hard drives, optical drives, flash drives, or the like.

Each computing unit 2202A to 2202D can have a processor 2222A, 2222B, 2222C and 2222D and associated local non-transitory, computer-readable storage media, such as a memory device 2224A, 2224B, 2224C and 2224D and a storage device 2226A, 2226B, 2226C and 2226D. Each processor 2222A to 2222D may be a multiple core unit, such as a multiple core central processing unit (CPU) or a graphics processing unit (GPU). Each memory device 2224A to 2224D may include ROM and/or RAM used to store program instructions for directing the corresponding processor 2222A to 2222D to implement the techniques described herein. Each storage device 2226A to 2226D may include one or more hard drives, optical drives, flash drives, or the like. In addition, each storage device 2226A to 2226D may be used to provide storage for models, intermediate results, data, images, or code associated with operations, including code used to implement at least a portion of the mud motor stall event identification techniques described herein.

The present techniques are not limited to the architecture or unit configuration illustrated in FIG. 22. For example, any suitable processor-based device may be utilized for implementing at least a portion of the mud motor stall event identification techniques described herein, including (without limitation) personal computers, laptop computers, computer workstations, mobile devices, and multi-processor servers or workstations with (or without) shared memory. Moreover, at least a portion of the mud motor stall event identification techniques described herein may be implemented on application specific integrated circuits (ASICs) or very-large-scale integrated (VLSI) circuits. In fact, those skilled in the art may utilize any number of suitable structures capable of executing logical operations according to embodiments described herein.

FIG. 23 is a block diagram of an exemplary non-transitory, computer-readable storage medium (or media) 2300 that may be used for the storage of data and modules of program instructions for implementing mud motor stall event identification in accordance with the present techniques. The non-transitory, computer-readable storage medium 2300 may include a memory device, a hard disk, and/or any number of other devices, as described with respect to FIG. 22. A processor 2302 may access the non-transitory, computer-readable storage medium 2300 over a bus or network 2304. While the non-transitory, computer-readable storage medium 2300 may include any number of modules for implementing the techniques described herein, in some embodiments, the non-transitory, computer-readable storage medium 2300 includes a mud motor stall event identification module 2306 and a borehole drilling operation management module 2308. Moreover, such modules may further include any number of sub-modules for carrying out embodiments of the present techniques.

### Exemplary Embodiments of Present Techniques

In one or more embodiments, the present techniques may be susceptible to various modifications and alternative forms, such as the following embodiments as noted in paragraphs 1 to 20:

1. A method for identifying at least one mud motor stall event during a borehole drilling operation that is carried out using a drilling assembly comprising a downhole mud motor, the method comprising: receiving, via a computing system, drilling sensor data that comprise a pressure measurement signal for a borehole drilling operation; calculating, via the computing system, a smoothed pressure signal using the received pressure measurement signal; calculating, via the computing system, a pressure fluctuation signal using the received pressure measurement signal and the calculated smoothed pressure signal; determining, via the computing system, a pressure fluctuation distribution dataset using a subset of data for the calculated pressure fluctuation signal; calculating, via the computing system, a set of statistical values from the determined pressure fluctuation distribution dataset, where the calculated set of statistical values comprises a pressure fluctuation value for a first selected percentile value and probability distribution parameters that characterize a selected theoretical probability distribution function; calculating, via the computing system, a theoretical pressure fluctuation value for a second selected percentile value using the calculated probability distribution parameters for the selected theoretical probability distribution function; identifying, via the computing system, at least one mud motor stall event when a pressure measurement value from the calculated pressure fluctuation signal is greater than the calculated pressure fluctuation value for the first selected percentile value and is greater than the calculated theoretical pressure fluctuation value for the second selected percentile value multiplied by a prescribed numerical value; and utilizing the at least one identified mud motor stall event to manage the borehole drilling operation

2. The method of paragraph 1, comprising: determining trends for a plurality of mud motor stall events that occur over time; and utilizing the trends, in combination with the at least one identified mud motor stall event, to manage the borehole drilling operation.

3. The method of paragraph 1 or 2, wherein the selected theoretical probability distribution function comprises a Gaussian distribution, and wherein the calculated set of statistical values comprises a mean and a standard deviation.

4. The method of any of paragraphs 1 to 3, comprising identifying the subset of data for determining the pressure fluctuation distribution dataset by filtering out data based on an analysis of at least one of operational activities, ranges for set points parameters, or formation characteristics.

5. The method of any of paragraphs 1 to 4, comprising obtaining the drilling sensor data during a period of time when control system set points for the borehole drilling operation are steady.

6. The method of any of paragraphs 1 to 5, comprising selecting the theoretical probability distribution function such that the theoretical probability distribution function comprises all data from the subset of data used to determine the pressure fluctuation distribution dataset except for data in an upper percentile range and data in a corresponding lower percentile range.

7. The method of any of paragraphs 1 to 6, comprising: utilizing a plurality of identified mud motor stall events over a period of time to analyze a cumulative severity of mud motor damage over the period of time; and determining an optimal time to replace the mud motor based on the cumulative severity of mud motor damage over the period of time.

8. The method of any of paragraphs 1 to 7, wherein calculating the smoothed pressure signal using the received pressure measurement signal comprises: performing signal smoothing on the received pressure measurement signal to generate an initial smoothed pressure signal; comparing the initial smoothed pressure signal with a processed pressure measurement signal; and calculating the smoothed pressure signal based on the comparison between the initial smoothed pressure signal and the processed pressure measurement signal.

9. A method for identifying at least one mud motor stall event during a borehole drilling operation that is carried out using a drilling assembly comprising a downhole mud motor, the method comprising: receiving, via a computing system, drilling sensor data that comprise a pressure measurement signal for a borehole drilling operation; calculating, via the computing system, a smoothed pressure signal using the received pressure measurement signal; calculating, via the computing system, a pressure fluctuation signal using the received pressure measurement signal and the calculated smoothed pressure signal; determining, via the computing system, a pressure fluctuation distribution dataset using a subset of data for the calculated pressure fluctuation signal; calculating, via the computing system, a set of statistical values from the determined pressure fluctuation distribution dataset, where the calculated set of statistical values comprises pressure fluctuation values for first selected percentile values and probability distribution parameters that characterize a selected theoretical probability distribution function; calculating, via the computing system, theoretical pressure fluctuation values using second selected percentile values and the calculated probability distribution parameters for the selected theoretical probability distribution function; identifying, via the computing system, at least one mud motor stall event when a pressure measurement value from the calculated pressure fluctuation signal is greater than a pressure cutoff value, where the pressure cutoff value is determined using the first selected percentile values, the second selected percentile values, the pressure fluctuation values, and the theoretical pressure fluctuation values; and utilizing the at least one identified mud motor stall event to manage the borehole drilling operation.

10. The method of paragraph 9, comprising: determining trends for a plurality of mud motor stall events that occur over time; and utilizing the trends, in combination with the at least one identified mud motor stall event, to manage the borehole drilling operation.

11. The method of paragraph 9 or 10, wherein the selected theoretical probability distribution function comprises a Gaussian distribution, and wherein the calculated set of statistical values comprises a mean and a standard deviation.

12. The method of any of paragraphs 9 to 11, comprising identifying the subset of data for determining the pressure fluctuation distribution dataset by filtering out data based on an analysis of at least one of operational activities, ranges for set points parameters, or formation characteristics.

13. The method of any of paragraphs 9 to 12, comprising obtaining the drilling sensor data during a period of time when control system set points for the borehole drilling operation are steady.

14. The method of any of paragraphs 9 to 13, comprising selecting the theoretical probability distribution function such that the theoretical probability distribution function comprises all data from the subset of data used to determine the pressure fluctuation distribution dataset except for data in an upper percentile range and data in a corresponding lower percentile range.

15. The method of any of paragraphs 9 to 14, comprising: utilizing a plurality of identified mud motor stall events over a period of time to analyze a cumulative severity of mud motor damage over the period of time; and determining an optimal time to replace the mud motor based on the cumulative severity of mud motor damage over the period of time.

16. A method for managing a borehole drilling operation that is carried out using a drilling assembly comprising a downhole mud motor, the method comprising: receiving, via a computing system, drilling sensor data that comprise a pressure measurement signal for a borehole drilling operation; calculating, via the computing system, a smoothed pressure signal using the received pressure measurement signal; calculating, via the computing system, a pressure fluctuation signal using the received pressure measurement signal and the calculated smoothed pressure signal; determining, via the computing system, a pressure fluctuation distribution dataset using a subset of the data for the calculated pressure fluctuation signal; calculating, via the computing system, a pressure fluctuation value for a selected percentile value using the determined pressure fluctuation distribution dataset; normalizing, via the computing system, the pressure fluctuation value using a selected weighting parameter value; repeating the calculation and the normalization of the pressure fluctuation value a plurality of times for a plurality of selected percentile values to obtain a time-based or depth-based signal of normalized pressure fluctuation values; an utilizing the normalized time-based or depth-based signal of normalized pressure fluctuation values to manage the borehole drilling operation.

17. The method of paragraph 16, comprising: determining trends for a plurality of normalized time-based or depth-based signals of normalized pressure fluctuation values over time; and utilizing the trends, in combination with the normalized time-based or depth-based signals of normalized pressure fluctuation values, to manage the borehole drilling operation.

18. The method of paragraph 16 or 17, comprising identifying the subset of data for determining the pressure fluctuation distribution dataset by filtering out data based on an analysis of at least one of operational activities, ranges for set points parameters, or formation characteristics.

19. The method of any of paragraphs 16 to 18, comprising obtaining the drilling sensor data during a period of time when control system set points for the borehole drilling operation are steady.

20. The method of any of paragraphs 16 to 19, comprising: utilizing a plurality of identified mud motor stall events over a period of time to analyze a cumulative severity of mud motor damage over the period of time; and determining an optimal time to replace the mud motor based on the cumulative severity of mud motor damage over the period of time.

While the embodiments described herein are well-calculated to achieve the advantages set forth, it will be appreciated that such embodiments are susceptible to modification, variation, and change without departing from the spirit thereof. In other words, the particular embodiments described herein are illustrative only, as the teachings of the present techniques may be modified and practiced in different but equivalent manners apparent to those skilled in the art having the benefit of the teachings herein. Furthermore, no limitations are intended on the details of formulation, construction, or design herein shown, other than as described in the claims below. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, the present techniques include all alternatives, modifications, and equivalents falling within the true spirit and scope of the appended claims.

1. A method for identifying at least one mud motor stall event during a borehole drilling operation that is carried out using a drilling assembly comprising a downhole mud motor, the method comprising:
receiving, via a computing system, drilling sensor data that comprise a pressure measurement signal for a borehole drilling operation;
calculating, via the computing system, a smoothed pressure signal using the received pressure measurement signal;
calculating, via the computing system, a pressure fluctuation signal using the received pressure measurement signal and the calculated smoothed pressure signal;
determining, via the computing system, a pressure fluctuation distribution dataset using a subset of data for the calculated pressure fluctuation signal;
calculating, via the computing system, a set of statistical values from the determined pressure fluctuation distribution dataset, wherein the calculated set of statistical values comprises a pressure fluctuation value for a first selected percentile value and probability distribution parameters that characterize a selected theoretical probability distribution function;
calculating, via the computing system, a theoretical pressure fluctuation value for a second selected percentile value using the calculated probability distribution parameters for the selected theoretical probability distribution function;
identifying, via the computing system, at least one mud motor stall event when a pressure measurement value from the calculated pressure fluctuation signal is greater than the calculated pressure fluctuation value for the first selected percentile value and is greater than the calculated theoretical pressure fluctuation value for the second selected percentile value multiplied by a prescribed numerical value; and
utilizing the at least one identified mud motor stall event to manage the borehole drilling operation.

2. The method of claim 1, comprising:
determining trends for a plurality of mud motor stall events that occur over time; and
utilizing the trends, in combination with the at least one identified mud motor stall event, to manage at least one of the borehole drilling operation or another borehole drilling operation.

3. The method of claim 1, wherein the selected theoretical probability distribution function comprises a Gaussian distribution, and wherein the calculated set of statistical values comprises a mean and a standard deviation.

4. The method of claim 1, comprising identifying the subset of data for determining the pressure fluctuation distribution dataset by filtering out data based on an analysis of at least one of operational activities, ranges for set points parameters, or formation characteristics.

5. The method of claim 1, comprising obtaining the drilling sensor data during a period of time when control system set points for the borehole drilling operation are steady.

6. The method of claim 1, comprising selecting the theoretical probability distribution function such that the theoretical probability distribution function comprises all data from the subset of data used to determine the pressure fluctuation distribution dataset except for data in an upper percentile range and data in a corresponding lower percentile range.

7. The method of claim 1, comprising:
utilizing a plurality of identified mud motor stall events over a period of time to analyze a cumulative severity of mud motor damage over the period of time; and
determining an optimal time to replace the downhole mud motor based on the cumulative severity of mud motor damage over the period of time.

8. The method of claim 1, wherein calculating the smoothed pressure signal using the received pressure measurement signal comprises:
performing signal smoothing on the received pressure measurement signal to generate an initial smoothed pressure signal;
comparing the initial smoothed pressure signal with a processed pressure measurement signal; and
calculating the smoothed pressure signal based on the comparison between the initial smoothed pressure signal and the processed pressure measurement signal.

9. A method for identifying at least one mud motor stall event during a borehole drilling operation that is carried out using a drilling assembly comprising a downhole mud motor, the method comprising:
receiving, via a computing system, drilling sensor data that comprise a pressure measurement signal for a borehole drilling operation;
calculating, via the computing system, a smoothed pressure signal using the received pressure measurement signal;
calculating, via the computing system, a pressure fluctuation signal using the received pressure measurement signal and the calculated smoothed pressure signal;
determining, via the computing system, a pressure fluctuation distribution dataset using a subset of data for the calculated pressure fluctuation signal;
calculating, via the computing system, a set of statistical values from the determined pressure fluctuation distribution dataset, wherein the calculated set of statistical values comprises pressure fluctuation values for first selected percentile values and probability distribution parameters that characterize a selected theoretical probability distribution function;
calculating, via the computing system, theoretical pressure fluctuation values using second selected percentile values and the calculated probability distribution parameters for the selected theoretical probability distribution function;
identifying, via the computing system, at least one mud motor stall event when a pressure measurement value from the calculated pressure fluctuation signal is greater than a pressure cutoff value, where the pressure cutoff value is determined using the first selected percentile values, the second selected percentile values, the pressure fluctuation values, and the theoretical pressure fluctuation values; and
utilizing the at least one identified mud motor stall event to manage the borehole drilling operation.

10. The method of claim 9, comprising:
determining trends for a plurality of mud motor stall events that occur over time; and
utilizing the trends, in combination with the at least one identified mud motor stall event, to manage at least one of the borehole drilling operation or another borehole drilling operation.

11. The method of claim 9, wherein the selected theoretical probability distribution function comprises a Gaussian distribution, and wherein the calculated set of statistical values comprises a mean and a standard deviation.

12. The method of claim 9, comprising identifying the subset of data for determining the pressure fluctuation distribution dataset by filtering out data based on an analysis of at least one of operational activities, ranges for set points parameters, or formation characteristics.

13. The method of claim 9, comprising obtaining the drilling sensor data during a period of time when control system set points for the borehole drilling operation are steady.

14. The method of claim 9, comprising selecting the theoretical probability distribution function such that the theoretical probability distribution function comprises all data from the subset of data used to determine the pressure fluctuation distribution dataset except for data in an upper percentile range and data in a corresponding lower percentile range.

15. The method of claim 9, comprising:
utilizing a plurality of identified mud motor stall events over a period of time to analyze a cumulative severity of mud motor damage over the period of time; and
determining an optimal time to replace the downhole mud motor based on the cumulative severity of mud motor damage over the period of time.

16. A method for managing a borehole drilling operation that is carried out using a drilling assembly comprising a downhole mud motor, the method comprising:
receiving, via a computing system, drilling sensor data that comprise a pressure measurement signal for a borehole drilling operation;
calculating, via the computing system, a smoothed pressure signal using the received pressure measurement signal;
calculating, via the computing system, a pressure fluctuation signal using the received pressure measurement signal and the calculated smoothed pressure signal;
determining, via the computing system, a pressure fluctuation distribution dataset using a subset of the data for the calculated pressure fluctuation signal;
calculating, via the computing system, a pressure fluctuation value for a selected percentile value using the determined pressure fluctuation distribution dataset;
normalizing, via the computing system, the pressure fluctuation value using a selected weighting parameter value;
repeating the calculation and the normalization of the pressure fluctuation value a plurality of times for a plurality of selected percentile values to obtain a time-based or depth-based signal of normalized pressure fluctuation values; and
utilizing the normalized time-based or depth-based signal of normalized pressure fluctuation values to manage the borehole drilling operation.

17. The method of claim 16, comprising:
determining trends for a plurality of normalized time-based or depth-based signals of normalized pressure fluctuation values over time; and
utilizing the trends, in combination with the normalized time-based or depth-based signals of normalized pressure fluctuation values, to manage the borehole drilling operation.

18. The method of claim 16, comprising identifying the subset of data for determining the pressure fluctuation distribution dataset by filtering out data based on an analysis of at least one of operational activities, ranges for set points parameters, or formation characteristics.

19. The method of claim 16, comprising obtaining the drilling sensor data during a period of time when control system set points for the borehole drilling operation are steady.

20. The method of claim 16, comprising:
utilizing a plurality of identified mud motor stall events over a period of time to analyze a cumulative severity of mud motor damage over the period of time; and
determining an optimal time to replace the downhole mud motor based on the cumulative severity of mud motor damage over the period of time.
